(19) United States
(12) Patent Application Publication
(10) Pub. No.: US 2024/0386106 A1
(43) Pub. Date: Nov. 21, 2024

(54) Intelligent Distributed Ledger Based Smart Contract Orchestration for Preserving and Self-Healing of Configuration Fraud with Smart Device

(71) Applicant: Bank of America Corporation, Charlotte, NC (US)

(72) Inventors: Maneesh Kumar Sethia, Hyderabad (IN); Vibhu Srivastava, Hyderabad (IN); Ashok Reddy Buthukuri, Huntersville, NC (US); Ankit Jain Bohra, Secunderabad (IN)

(21) Appl. No.: 18/197,164

(22) Filed: May 15, 2023

(51) Int. Cl. G06F 21/56; G06F 21/57

(52) U.S. Cl. CPC G06F 21/566; G06F 21/577; G06F 2221/033; G06Q 20/36

(57) ABSTRACT

Aspects of this disclosure relate to systems and methods to determine whether an application is misconfigured or malicious using smart contracts stored on a distributed ledger and a transferred deep learning system. A smart contract is generated and assigned rules for monitoring an application session on a user computing device when an application session associated with the application is initiated. The smart contract denies or grants the application session permission to access user data and shuts down the application session when a malicious indication is detected in configuration data associated with the application based on rules assigned to the smart contract. The malicious indication is output by a deep learning module trained on historical configuration data associated with the application. The deep learning module transfers layers to an enterprise deep learning module on an enterprise platform to determine a misconfiguration indication indicating the configuration data is misconfigured.

### TECHNICAL FIELD

Aspects of the disclosure relate to blockchain management, and more specifically, to use of smart contracts on a blockchain system for improved security involving applications on computing devices.

### BACKGROUND

Existing methods and systems involve the use of applications by enterprise organizations. There are potential security risks in allowing applications to interact with a system. Devices like smart phones and tablets are more prone to fraudulency, especially as consent is provided to applications and web browsers. Weakly configured applications and web browsers can be probed to intrude into sensitive data.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of this disclosure provide effective, efficient, scalable, and convenient technical solutions that address various security issues associated with applications used on computing devices. One or more of the aspects herein relate to the use of smart contracts on blockchains to provide security and self-help solutions associated with application problems. Additional aspects herein relate to the integration of deep learning-based techniques into security solutions associated with applications.

These and additional aspects will be appreciated with the benefit of the disclosures discussed in further detail below.

In accordance with one or more embodiments, systems and methods leverage smart contracts to monitor an application session associated with an application on a user computing device. The system comprises a user computing device. The user computing device comprises a user memory and one or more user processors. The user memory stores a monitoring module, a deep learning module, an application, configuration data, user data, a distributed ledger, and/or computer readable instructions, that when executed by the user processors, perform one or more functions and/or operations described herein. The user computing device initiates an application session associated with an application. The application session requests permission to access user data. A first rule is determined for a smart contract related to denying permission to the application session based on the application session bypassing the smart contract. A second rule is determined for the smart contract related to denying permission to the application session based on detecting unknown data not associated with the application in configuration data associated with the application. A third rule is determined for the smart contract related to shutting down the application session based on detecting a malicious indication in the configuration data. The monitoring module generates the smart contract assigned the first rule, second rule, and third rule. The monitoring module extracts configuration data associated with the application and binds the smart contract with the configuration data. The smart contract is added to the distributed ledger for monitoring the application session. The smart contract determines the application session does not comply with the rules of the smart contract. The smart contract denies the application session permission to access user data.

In some embodiments, the system also comprises an enterprise platform. The enterprise platform comprises an enterprise memory and one or more enterprise processors. The enterprise memory stores an enterprise deep learning module, an application, configuration data, enterprise data, and/or computer readable instructions, that when executed by the enterprise processor(s), perform one or more functions and/or operations described herein. If the smart contract determines the application session does comply with the rules of the smart contract, then grant, by the smart contract, the application session permission to access user data. The smart contract monitors the application session executing on the user computing device and the application session complies with the rules of the smart contract. The user computing device receives from the enterprise platform, enterprise data associated with the application.

In some embodiments, if the smart contract determines the application session does comply with the rules of the smart contract, then grant, by the smart contract, the application session permission to access user data. The smart contract monitors the application session executing on the user computing device and the application session does not comply with the third rule of the smart contract. The smart contract shuts down the application session based on the third rule assigned to the smart contract. The user computing device blocks from the enterprise platform, enterprise data associated with the application.

In some embodiments, the configuration data is input into the deep learning module comprising input layers, training layers, and malicious output layers. The deep learning module is trained on historical configuration data. The deep learning module processes the configuration data. The deep learning module outputs the malicious indication for determining the third rule. The malicious indication indicates the application session is executing malicious requests.

In some embodiments, the user computing device sends the input layers and training layers to the enterprise platform. The enterprise platform adds the input layers and training layers to the enterprise deep learning module. The enterprise deep learning module comprises input layers, training layers, and misconfiguration output layers. The configuration data is input into the enterprise deep learning module. The enterprise deep learning module processes the configuration data. The enterprise deep learning module outputs a misconfiguration indication indicating the configuration data is misconfigured. The enterprise platform blocks from sending the enterprise data to the user computing device based on the misconfiguration indication.

In some embodiments, the enterprise platform updates the configuration data based on the misconfiguration indication. The enterprise platform sends to the user computing device, the updated configuration data. The user computing device updates the configuration data based on the updated configuration data.

In some embodiments, the first rule and second rule are dynamically updated by a rules engine.

In some embodiments, the malicious indication is related to specific vulnerabilities associated with the application.

In some embodiments, the user computing device is a smart phone, tablet, smart watch, or laptop.

In some embodiments, the user data comprises password information, transaction information, location information, or personal information associated with the user computing device.

In some embodiments, the unknown data is malware data or virus data.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative example of centralized computer system in accordance with one or more illustrative aspects described herein.

FIG. 2 depicts an illustrative example of decentralized peer-to-peer (P2P) computer system that may be used in accordance with one or more illustrative aspects described herein.

FIG. 3A depicts an illustrative example of a full node computing device that may be used in accordance with one or more illustrative aspects described herein.

FIG. 3B depicts an illustrative example of a lightweight node computing device that may be used in accordance with one or more illustrative aspects described herein.

FIG. 4 depicts an illustrative example of a suitable computing system environment that may be used in accordance with one or more illustrative aspects described herein.

FIG. 5 depicts an illustrative example of a computing environment that may be used in accordance with one or more illustrative aspects described herein.

FIG. 6A depicts an illustrative event sequence that may be used in accordance with one or more illustrative aspects described herein.

FIG. 6B depicts an illustrative event sequence that may be used in accordance with one or more illustrative aspects described herein.

FIG. 6C depicts an illustrative event sequence that may be used in accordance with one or more illustrative aspects described herein.

FIG. 7A depicts an illustrative event sequence that may be used in accordance with one or more illustrative aspects described herein.

FIG. 7B depicts an illustrative event sequence that may be used in accordance with one or more illustrative aspects described herein.

FIG. 8 depicts an example computing environment that may be used in accordance with one or more illustrative aspects described herein.

FIG. 9A depicts an example alert message that may be used in accordance with one or more illustrative aspects described herein.

FIG. 9B depicts an example alert message that may be used in accordance with one or more illustrative aspects described herein.

### DETAILED DESCRIPTION

Various enterprise institutions incorporate the use of applications to perform various tasks, operations, and/or functions. Each time an application is executed by a user computing device, an application session associated with the application is initiated. Malicious attackers may attempt to tamper with configuration data associated with the application leading to data tampering, unauthorized data disclosure, and/or loss of operative control of the application. Significant technological problems may arise regarding the maintenance of operation and data control, as well as preservation of data integrity.

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways. It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

As a general introduction to the subject matter described in more detail below, aspects described herein are directed towards the methods and systems disclosed herein.

The disclosure provided herein is described, at least in part, in relation to a decentralized peer-to-peer (e.g., P2P) system specialized for the purpose of managing a blockchain. The decentralized P2P system may be comprised of computing devices that are distributed in multiple locations across a geographical area as opposed to a single location. The computing devices forming the decentralized P2P system may operate with each other to manage a blockchain, which may be a data structure used to store information related to the decentralized P2P system. More specifically, the blockchain may be a chronological linkage of data elements (e.g., blocks) which store data records relating to the decentralized computing system.

A user may access the decentralized P2P system through a specialized “wallet” that serves to uniquely identify the user and enable the user to perform functions related to the decentralized P2P network. Through the wallet, the user may be able to hold tokens, funds, and/or any other asset associated with the decentralized P2P system. Furthermore, the user may be able to use the wallet to request performance of network-specific functions related to the decentralized P2P system such as fund, token, and/or asset transfers. The various computing devices forming the decentralized P2P computing system may operate as a team to perform network-specific functions requested by the user. In performing the network-specific functions, the various computing devices may produce blocks that store the data generated during the performance of the network-specific functions and may add the blocks to the blockchain. After the block has been added to the blockchain, the wallet associated with the user may indicate that the requested network-specific function has been performed.

For example, a user may have a wallet which reflects that the user has five tokens associated with the decentralized P2P system. The user may provide a request to the decentralized P2P system to transfer the five tokens to a friend who also has a wallet. The various computing devices forming the decentralized P2P computing system may perform the request and transfer the five tokens from the wallet of the user to the wallet of the friend. In doing so, a block may be created by the various computing devices of the decentralized P2P computing system. The block may store data indicating that the five tokens were transferred from the wallet of the user to the wallet of the friend. The various computing devices may add the block to the blockchain. At such a point, the wallet of the user may reflect the transfer of the five tokens to the wallet of the friend, and may indicate a balance of zero. The wallet of the friend, however, may also reflect the transfer of the five tokens and may have a balance of five tokens.

In more detail, the decentralized P2P system may be specialized for the purpose of managing a distributed ledger, such as a private blockchain or a public blockchain, through the implementation of digital cryptographic hash functions, consensus algorithms, digital signature information, and network-specific protocols and commands. The decentralized P2P system (e.g., decentralized system) may be comprised of decentralized system infrastructure consisting of a plurality computing devices, either of a heterogeneous or homogenous type, which serve as network nodes (e.g., full nodes and/or lightweight nodes) to create and sustain a decentralized P2P network (e.g., decentralized network). Each of the full network nodes may have a complete replica or copy of a blockchain stored in memory and may operate in concert, based on the digital cryptographic hash functions, consensus algorithms, digital signature information, and network-specific protocols, to execute network functions and/or maintain inter-nodal agreement as to the state of the blockchain. Each of the lightweight network nodes may have at least a partial replica or copy of the blockchain stored in memory and may request performance of network functions through the usage of digital signature information, hash functions, and network commands. In executing network functions of the decentralized network, such as balance sheet transactions and smart contract operations, at least a portion of the full nodes forming the decentralized network may execute the one or more cryptographic hash functions, consensus algorithms, and network-specific protocols to register a requested network function on the blockchain. In some instances, a plurality of network function requests may be broadcasted across at least a portion of the full nodes of the decentralized network and aggregated through execution of the one or more digital cryptographic hash functions and by performance of the one or more consensus algorithms to generate a single work unit (e.g., block), which may be added in a time-based, chronological manner to the blockchain through performance of network-specific protocols.

While in practice the term “blockchain” may hold a variety of contextually derived meanings, the term blockchain, as used herein, refers to a concatenation of sequentially dependent data elements (e.g., blocks) acting as a distributed ledger that stores records relating to a decentralized computing system. Such data records may be related to those used by a particular entity or enterprise, such as a financial institution, and/or may be associated with a particular application and/or use case including, but not limited to, cryptocurrency, digital content storage and delivery, entity authentication and authorization, digital identity, marketplace creation and operation, internet of things (e.g., IoT), prediction platforms, election records, currency exchange and remittance, P2P transfers, ride sharing, trading platforms, and real estate, precious metal, and work of art registration and transference, among others. A “private blockchain” may refer to a blockchain of a decentralized private system in which only authorized computing devices are permitted to act as nodes in a decentralized private network and have access to the private blockchain. In some instances, the private blockchain may be viewable and/or accessible by authorized computing devices which are not participating as nodes within the decentralized private network, but still have proper credentials. A “public blockchain” may refer to a blockchain of a decentralized public system in which any computing devices may be permitted to act as nodes in a decentralized public network and have access to the public blockchain. In some instances, the public blockchain may be viewable and/or accessible by computing devices which are not participating as nodes within the decentralized public network.

Further, a “full node” or “full node computing device.” as used herein, may describe a computing device in a decentralized system which operates to create and maintain a decentralized network, execute requested network functions, and maintain inter-nodal agreement as to the state of the blockchain. In order to perform such responsibilities, a computing device operating as a full node in the decentralized system may have a complete replica or copy of the blockchain stored in memory, as well as executable instructions for the execution of hash functions, consensus algorithms, digital signature information, network protocols, and network commands. A “lightweight node,” “light node,” “lightweight node computing device.” or “light node computing device” may refer to a computing device in a decentralized system, which operates to request performance of network functions (e.g., balance sheet transactions, smart contract operations, and the like) within a decentralized network but without the capacity to execute requested network functions and maintain inter-nodal agreement as to the state of the blockchain. As such, a computing device operating as a lightweight node in the decentralized system may have a partial replica or copy of the blockchain. In some instances, network functions requested by lightweight nodes to be performed by the decentralized network may also be able to be requested by full nodes in the decentralized system.

“Network functions” and/or “network-specific functions,” as described herein, may relate to functions which are able to be performed by nodes of a decentralized P2P network. In some arrangements, the data generated in performing network-specific functions may or may not be stored on a blockchain associated with the decentralized P2P network. Examples of network functions may include “smart contract operations.” A smart contract operation, as used herein, may describe one or more operations performed by a “smart contract,” which may be one or more algorithms and/or programs associated with one or more nodes within a decentralized P2P network. For example, the one or more algorithms and/or programs may correspond to addition of a Non-fungible token (NFT) to a blockchain or querying of NFTs stored in a blockchain. Addition of NFTs may correspond to updating those stored in the blockchain. In another example, the one or more algorithms and/or programs performed by the smart contract may correspond to various functions and/or operations to block or allow an application from executing on a user computing device, an application from accessing user data, or the transmission of enterprise data to a user computing device.

In one or more aspects of the disclosure, a “digital cryptographic hash function,” as used herein, may refer to any function which takes an input string of characters (e.g., message), either of a fixed length or non-fixed length, and returns an output string of characters (e.g., hash, hash value, message digest, digital fingerprint, digest, and/or checksum) of a fixed length. Examples of digital cryptographic hash functions may include BLAKE (e.g., BLAKE-256, BLAKE-512, and the like), MD (e.g., MD2, MD4, MD5, and the like), Scrypt, SHA (e.g., SHA-1, SHA-256, SHA-512, and the like), Skein, Spectral Hash, SWIFT, Tiger, and so on. A “consensus algorithm,” as used herein and as described in further detail below, may refer to one or more algorithms for achieving agreement on one or more data values among nodes in a decentralized network. Examples of consensus algorithms may include proof of work (e.g., PoW), proof of stake (e.g., PoS), delegated proof of stake (e.g., DPoS), practical byzantine fault tolerance algorithm (e.g., PBFT), and so on. Furthermore, “digital signature information” may refer to one or more private/public key pairs and digital signature algorithms which are used to digitally sign a message and/or network function request for the purposes of identity and/or authenticity verification. Examples of digital signature algorithms which use private/public key pairs contemplated herein may include public key infrastructure (PKI), Rivest-Shamir-Adleman signature schemes (e.g., RSA), digital signature algorithm (e.g., DSA), Edwards-curve digital signature algorithm, and the like. A “wallet,” as used herein, may refer to one or more data and/or software elements (e.g., digital cryptographic hash functions, digital signature information, and network-specific commands) that allow a node in a decentralized P2P network to interact with the decentralized P2P network. A wallet may be associated with a public key, which may serve to identify the wallet. In requesting performance of network operations, a private key associated with the wallet may be used to digitally sign the network operation requests.

As will be described in further detail below, a decentralized P2P system implementing a blockchain data structure may provide solutions to technological problems existing in current centralized system constructs with traditional data storage arrangements. For example, conventional data storage arrangements that use a central data authority have a single point of failure (namely, the central storage location) which, if compromised by a malicious attacker, can lead to data tampering, unauthorized data disclosure, and/or loss of operative control of the processes performed by the centralized system. The implementation of a blockchain data structure in a decentralized P2P system acts as a safeguard against unreliable and/or malicious nodes acting in the decentralized P2P network to undermine the work efforts of the other nodes, e.g., by providing byzantine fault tolerance within the network.

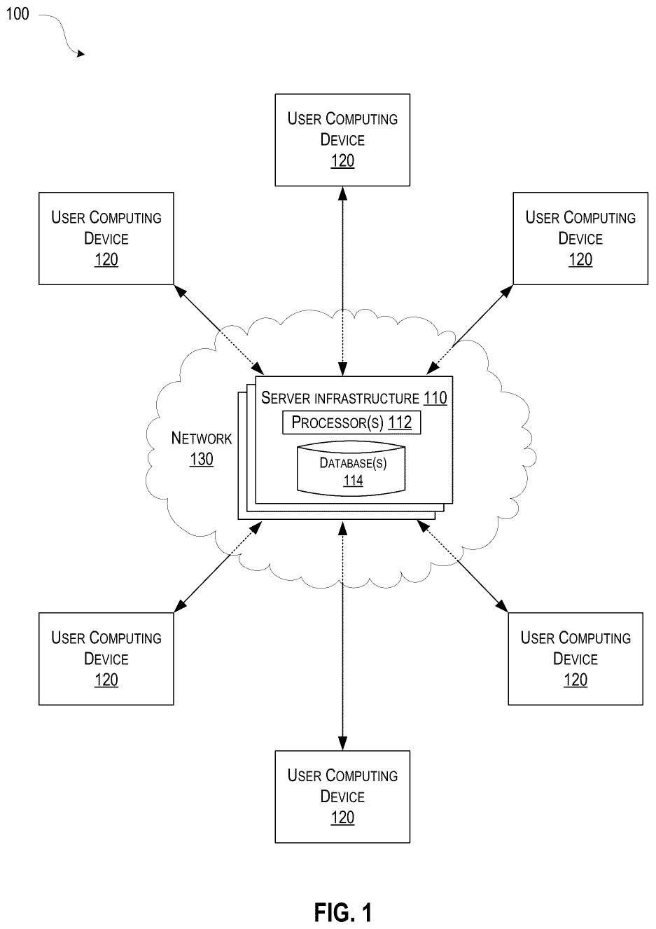

FIG. 1 depicts an illustrative example of centralized computer system 100 in accordance with one or more illustrative aspects described herein. Centralized computer system 100 may comprise one or more computing devices including at least server infrastructure 110 and user computing devices 120. Each of user computing devices 120 may be configured to communicate with server infrastructure 110 through network 130. In some arrangements, centralized computer system 100 may include additional computing devices and networks that are not depicted in FIG. 1, which also may be configured to interact with server infrastructure 110 and, in some instances, user computing devices 120.

Server infrastructure 110 may be associated with a distinct entity such as a company, school, government, and the like, and may comprise one or more personal computer(s), server computer(s), hand-held or laptop device(s), multiprocessor system(s), microprocessor-based system(s), set top box(es), programmable consumer electronic device(s), network personal computer(s) (PC), minicomputer(s), mainframe computer(s), distributed computing environment(s), and the like. Server infrastructure 110 may include computing hardware and software that may host various data and applications for performing tasks of the centralized entity and for interacting with user computing devices 120, as well as other computing devices. For example, each of the computing devices comprising server infrastructure 110 may include at least one or more processors 112 and one or more databases 114, which may be stored in memory of the one or more computing devices of server infrastructure 110. Through execution of computer-readable instructions stored in memory, the computing devices of server infrastructure 110 may be configured to perform functions of the centralized entity and store the data generated during the performance of such functions in databases 114.

In some arrangements, server infrastructure 110 may include and/or be part of enterprise information technology infrastructure and may host a plurality of enterprise applications, enterprise databases, and/or other enterprise resources. Such applications may be executed on one or more computing devices included in server infrastructure 110 using distributed computing technology and/or the like. In some instances, server infrastructure 110 may include a relatively large number of servers that may support operations of a particular enterprise or organization, such as a financial institution. Server infrastructure 110, in this embodiment, may generate a single centralized ledger for data received from the various user computing devices 120, which may be stored in databases 114.

Each of the user computing devices 120 may be configured to interact with server infrastructure 110 through network 130. In some instances, one or more of the user computing devices 120 may be configured to receive and transmit information corresponding to system requests through particular channels and/or representations of webpages and/or applications associated with server infrastructure 110. The system requests provided by user computing devices 120 may initiate the performance of particular computational functions such as data and/or file transfers at server infrastructure 110. In such instances, the one or more of the user computing devices may be internal computing devices associated with the particular entity corresponding to server infrastructure 110 and/or may be external computing devices which are not associated with the particular entity.

As stated above, centralized computer system 100 also may include one or more networks, which may interconnect one or more of server infrastructure 110 and one or more user computing devices 120. For example, centralized computer system 100 may include network 130. Network 130 may include one or more sub-networks (e.g., local area networks (LANs), wide area networks (WANs), or the like). Furthermore, centralized computer system 100 may include a local network configured to interlink each of the computing devices comprising server infrastructure 110.

Furthermore, in some embodiments, centralized computer system 100 may include a plurality of computer systems arranged in an operative networked communication arrangement with one another through a network, which may interface with server infrastructure 110, user computing devices 120, and network 130. The network may be a system specific distributive network receiving and distributing specific network feeds and identifying specific network associated triggers. The network may also be a global area network (GAN), such as the Internet, a wide area network (WAN), a local area network (LAN), or any other type of network or combination of networks. The network may provide for wireline, wireless, or a combination wireline and wireless communication between devices on the network.

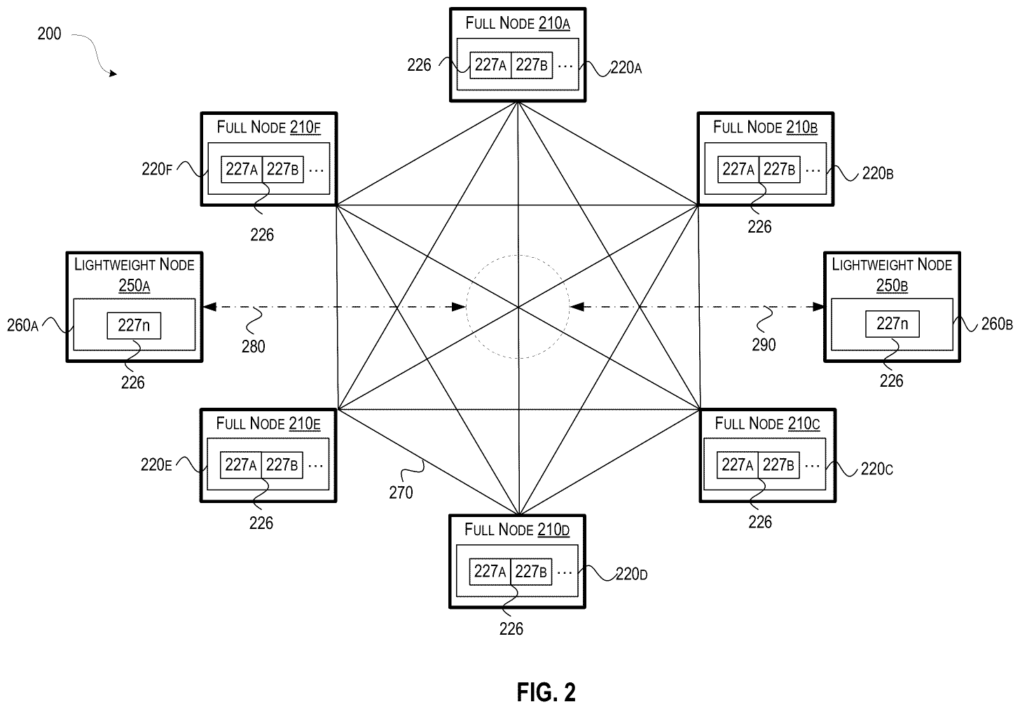

In the centralized computer system 100 described in regard to FIG. 1, server infrastructure 110 may serve as a central authority which manages at least a portion of the computing data and actions performed in relation to the particular entity associated with server infrastructure 110. As such, server infrastructure 110 of centralized computer system 100 provides a single point of failure which, if compromised by a malicious attacker, can lead to data tampering, unauthorized data disclosure, and/or loss of operative control of the processes performed by the server infrastructure 110 in relation to the particular entity associated with server infrastructure 110. In such a centralized construct in which a single point of failure (e.g., server infrastructure 110) is created, significant technological problems arise regarding maintenance of operation and data control, as well as preservation of data integrity. As will be described in further detail below in regard to FIG. 2, such technological problems existing in centralized computing arrangements may be solved by a decentralized P2P system implementing a blockchain data structure, even wholly within the server infrastructure 110.

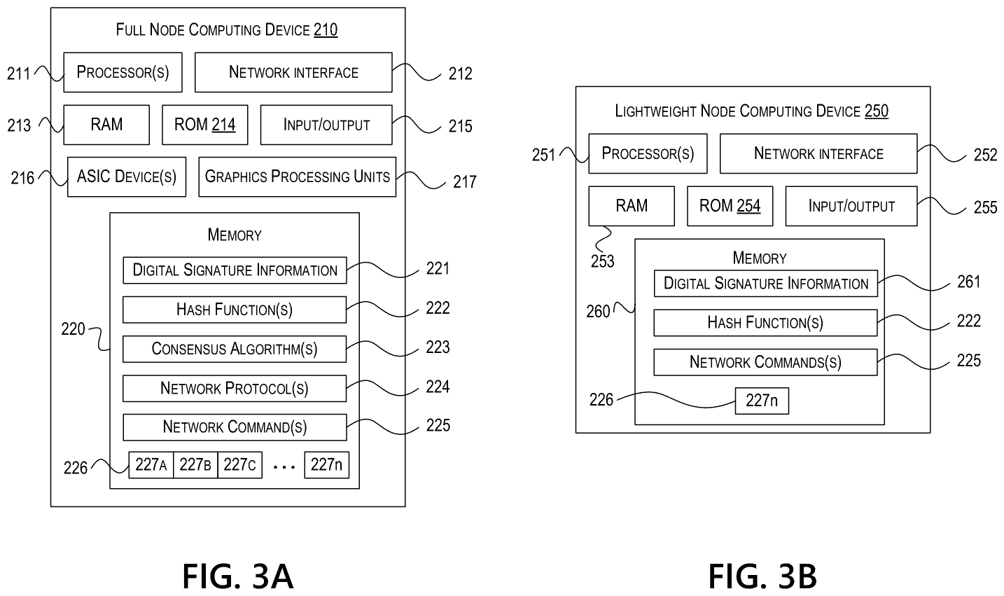

FIG. 2 depicts an illustrative example of decentralized P2P computer system 200 that may be used in accordance with one or more illustrative aspects described herein. Decentralized P2P computer system 200 may include a plurality of full node computing devices 210A, 210B, 210C, 210D, 210E, and 210F and lightweight node computing devices 250A and 250B, which may be respectively similar to full node computing device 210 described in regard to FIG. 3A and lightweight node computing device 250 described in regard to FIG. 3B. While a particular number of full node computing devices and lightweight node computing devices are depicted in FIG. 2, it should be understood that a number of full node computing devices and/or lightweight node computing devices greater or less than that of the depicted full node computing devices and lightweight node computing devices may be included in decentralized P2P computer system 200. Accordingly, any additional full node computing devices and/or lightweight node computing devices may respectively perform in the manner described below in regard to full node computing devices 210A-210F and lightweight node computing devices 250A and 250B in decentralized P2P computer system 200.

Each of full node computing devices 210A-210F may operate in concert to create and maintain decentralized P2P network 270 of decentralized P2P computer system 200. In creating decentralized P2P network 270 of decentralized P2P computer system 200, processors, ASIC devices, and/or graphics processing units (e.g., GPUs) of each full node computing device 210A-210F may execute network protocols which may cause each full node computing device 210A-210F to form a communicative arrangement with the other full node computing devices 210A-210F in decentralized P2P computer system 200 and thereby create decentralized P2P network 270. Furthermore, the execution of network protocols by the processors, ASIC devices, and/or GPUs of full node computing devices 210A-210F may cause full node computing devices 210A-210F to execute network functions related to blockchain 226 and maintain decentralized P2P network 270.

Lightweight node computing devices 250A and 250B may request execution of network functions related to decentralized P2P network 270. In order to request execution of network functions, such as balance sheet transaction and/or smart contract operations, processors of lightweight node computing devices 250A and 250B may execute network commands to broadcast the network functions to decentralized P2P network 270 comprising full node computing devices 210A-210F.

For example, lightweight node computing device 250A may request execution of a balance sheet transaction related to decentralized P2P network 270, which may entail a data transfer from a wallet associated with lightweight node computing device 250A to a wallet associated with lightweight node 250B. In doing so, processors of lightweight node computing device 250A may execute network commands to broadcast balance sheet transaction network function request 280 to decentralized P2P network 270. Balance sheet transaction network function request 280 may include details about the data transfer such as data type and amount, as well as a data transfer amount to full node computing devices 210A-201F of decentralized P2P network 270 for executing balance sheet transaction network function request 280. Balance sheet transaction network function request 280 may further include the public key associated with the wallet of lightweight node computing device 250B. Processors of lightweight node computing device 250A may execute digital signature algorithms to digitally sign balance sheet transaction network function request 280 with the private key associated with the wallet of lightweight node computing device 250A.

At decentralized P2P network 270, balance sheet transaction network function request 280 may be broadcasted to each of full node computing devices 210A-210F through execution of network protocols by full node computing devices 210A-210F. In order to execute balance sheet transaction network function request 280 and maintain inter-nodal agreement as to the state of blockchain 226, processors, ASIC devices, and/or GPUs of full node computing devices 210A-210F may execute network protocols to receive broadcast of the network function through decentralized P2P network 270 and from lightweight node computing device 250A. Processors, ASIC devices, and/or GPUs of full node computing devices 210A-210F may execute hash functions to generate a digest of balance sheet transaction network function request 280. The resultant digest of balance sheet transaction network function request 280 may, in turn, be hashed with the block hash of the most immediately preceding block of blockchain 226. Processors, ASIC devices, and/or GPUs of full node computing devices 210A-210F may execute consensus algorithms to identify a numerical value (e.g., nonce) corresponding to the particular executed consensus algorithm and related to the digest that combines the digest of the balance sheet transaction network function request 280 and the block hash of the most immediately preceding block of blockchain 226.

For example, in embodiments in which the consensus algorithm is proof of work (e.g., PoW), processors, ASIC devices, and/or GPUs of full node computing devices 210A-210F may perform a plurality of hashing operations to identify a nonce that, when hashed with the digest that combines the digest of the balance sheet transaction network function request 280 and the block hash of the most immediately preceding block of blockchain 226, produces a hash of a predetermined alphanumerical format. Such a predetermined alphanumerical format may include a predetermined number of consecutive alphanumerical characters at a predetermined position within the resultant digest that combines the nonce, digest of the balance sheet transaction network function request 280, and block hash of the most immediately preceding block of blockchain 226.

In embodiments in which the consensus algorithm is proof of stake (e.g., PoS), a private key associated with one of full node computing devices 210A-210F may be pseudo-randomly selected, based on balance sheet holdings associated with the public keys of full node computing devices 210A-210F, to serve as the nonce. For example, through execution of the PoS consensus algorithm, full node computing devices 210A-210F are entered into a lottery in which the odds of winning are proportional to a balance sheet amount associated the wallet of each of full node computing devices 210A-210F, wherein a larger balance sheet amount corresponds to a higher probability to win the lottery. The POS consensus algorithm may cause a full node computing device from full node computing devices 210A-210F to be selected, and the public key of the wallet of the selected full node computing device to be used as the nonce.

In embodiments in which the consensus algorithm is delegated proof of stake (e.g., DpoS), a group of delegates are chosen from full node computing devices 210A-210F by each of computing devices 210A-210F, wherein full node computing devices 210A-210F are allowed to choose delegates based on balance sheet holdings associated with the respective wallets. Full node computing devices 210A-210F, however, may not choose themselves to be delegates. Once the group of delegates are chosen, the group of delegates from full node computing devices 210A-210F select a public key associated with a wallet of one of full node computing devices 210A-210F to serve as the nonce.

In embodiments in which the consensus algorithm is practical byzantine fault tolerance algorithm (e.g., PBFT), each of full node computing devices 210A-210F are associated with a particular status and/or ongoing specific information associated with the respective public key of the full node computing devices. Each of full node computing devices 210A-210F receive a message through decentralized P2P network 270 based on network protocols. Based on the received message and particular status and/or ongoing specific information, each of full node computing devices 210A-210F perform computational tasks and transmit a response to the tasks to each of the other full node computing devices 210A-210F. A public key of a wallet associated with a particular full node computing device from full node computing devices 210A-210F is selected by each of full node computing devices 210A-210F based on the response of the particular full node computing device best fulfilling criteria determined based on the network protocols.

The identification of the nonce enables processors, ASIC devices, and/or GPUs of the full node computing device from full node computing devices 210A-210F corresponding to the nonce to create a new block with a block header (e.g., block hash), which is a digest that combines the digest of balance sheet transaction network function request 280, the block hash of the most immediately preceding block, and the identified nonce. Processors, ASIC devices, and/or GPUs of the full node computing device from full node computing devices 210A-210F may execute network protocols to add the new block to blockchain 226 and broadcast the new block to the other full node computing devices in the decentralized P2P network 270. In some arrangements, the new block may also be time-stamped at a time corresponding to the addition to blockchain 226. Furthermore, as a reward for adding the new block to blockchain 226, the full node computing device from full node computing devices 210A-210F may be allowed, per the network protocols, to increase balance sheet holdings associated with itself by a predetermined amount. In some arrangements, each of full node computing devices 210A-210F may receive an equal portion of the data transfer amount specified by lightweight node computing device 250A for executing balance sheet transaction network function request 280. After the new block has been added to blockchain 226, balance sheet transaction network function request 280 may be considered to be executed and the data transfer from the wallet associated with lightweight node computing device 250A to the wallet associated with lightweight node 250B may be registered.

As stated above, in some arrangements, a plurality of network function requests may be broadcasted across decentralized network P2P network 270. Processors, ASIC devices, and/or GPUs of full node computing devices 210A-210F may execute network protocols to receive broadcast of each of the network functions, including balance sheet transaction network function request 280, through decentralized P2P network 270 and from the requesting entities, including lightweight node computing device 250A. Processors, ASIC devices, and/or GPUs of full node computing devices 210A-210F may execute hash functions to generate a hash tree (e.g., Merkle tree) of the requested network functions, which culminates in a single digest (e.g., root digest, root hash, and the like) that comprises the digests of each of the requested network functions, including balance sheet transaction network function request 280. The root digest of the requested network function may, in turn, be hashed with the block hash of the most immediately preceding block of blockchain 226. Processors, ASIC devices, and/or GPUs of full node computing devices 210A-210B may execute consensus algorithms in the manner described above to identify a nonce corresponding to the particular executed consensus algorithm and related to the digest that combines the root digest of the requested network functions and the block hash of the most immediately preceding block of blockchain 226. The identification of the nonce enables processors, ASIC devices, and/or GPUs of the full node computing device from full node computing devices 210A-210F to create a new block with a block header (e.g., block hash), which is a digest that combines the root digest of the network function requests, the block hash of the most immediately preceding block, and the identified nonce. Processors, ASIC devices, and/or GPUs of the full node computing device from full node computing devices 210A-210F may execute network protocols to add the new block to blockchain 226 and broadcast the new block to the other full node computing devices in the decentralized P2P network 270. In some arrangements, the new block may also be time-stamped at a time corresponding to the addition to blockchain 226. Furthermore, as a reward for adding the new block to blockchain 226, the full node computing device from full node computing devices 210A-210F may be allowed, per the network protocols, to increase a balance sheet holdings amount associated with itself by a predetermined amount. In some arrangements, each of full node computing devices 210A-210F may receive an equal portion of the data transfer amount specified by each of the network function requests. After the new block has been added to blockchain 226, each of the network functions requests, including balance sheet transaction network function request 280, may be considered to be executed and the data transfer from the private/public key associated with lightweight node computing device 250A to the private/public key associated with lightweight node 250B may be registered.

While the description provided above is made in relation to a balance sheet transaction involving lightweight node computing device 250A and lightweight node computing device 250B, it is to be understood that balance sheet transactions are not limited to lightweight node computing device 250A and lightweight node computing device 250B, but rather may be made across any of the full node computing devices and/or lightweight node computing devices in decentralized P2P system 200.

For another example, lightweight node computing device 250B may request a smart contract operation related to decentralized P2P network 270, which may facilitate a dual data transfer between a wallet associated with lightweight node computing device 250B and a wallet associated with another node in decentralized P2P network 270, such as lightweight node computing device 250A, based on fulfillment of programmatic conditions established by a smart contract. Processors of lightweight node computing device 250B may execute network commands to broadcast smart contract operation network function request 290 to decentralized P2P network 270. Smart contract operation network function request 290 may include details about the data transfer such as data type and amount, as well as a data transfer amount to full node computing devices 210A-210F of decentralized P2P network 270 for executing the smart contract corresponding to smart contract operation network function request 290. Smart contract operation network function request 290 may further include the public key associated with the smart contract. Processors of lightweight node computing device 250B may execute digital signature algorithms to digitally sign smart contract operation network function request 290 with the private key associated with the wallet of lightweight node computing device 250B.

At decentralized P2P network 270, smart contract operation network function request 290 may be broadcasted to each of full node computing devices 210A-210F through execution of network protocols by full node computing devices 210A-210F. In order to execute smart contract operation network function request 290 and maintain inter-nodal agreement as to the state of blockchain 226, processors, ASIC devices, and/or GPUs of full node computing devices 210A-210F may execute network protocols to receive broadcast of the network function through a decentralized P2P network 270 and from lightweight node computing device 250B. Processors, ASIC devices, and/or GPUs of full node computing devices 210A-210F may execute hash functions to generate a digest of smart contract operation network function request 290. The resultant digest of smart contract operation network function request 290, in turn, may be hashed with the block hash of the most immediately preceding block of blockchain 226. Processors, ASIC devices, and/or GPUs of full node computing devices 210A-210F may execute consensus algorithms to identify a nonce corresponding to the particular executed consensus algorithm and related to the digest that combines the digest of smart contract operation network function request 290 and the block hash of the most immediately preceding block of blockchain 226.

The identification of the nonce enables processors, ASIC devices, and/or GPUs of the full node computing device from full node computing devices 210A-210F to create a new block with a block header (e.g., block hash), which is a digest that combines smart contract operation network function request 290, the block hash of the most immediately preceding block, and the identified nonce. Processors, ASIC devices, and/or GPUs of the full node computing device from full node computing devices 210A-210F may execute network protocols to add the new block to blockchain 226 and broadcast the new block to the other full node computing devices in the decentralized P2P network 270. In some arrangements, the new block may also be time-stamped at a time corresponding to the addition to blockchain 226. Furthermore, as a reward for adding the new block to blockchain 226, the full node computing device from full node computing devices 210A-210F may, per the network protocols, increase a balance sheet holdings amount associated with itself by a predetermined amount. In some arrangements, each of full node computing devices 210A-210F may receive an equal portion of the data transfer amount specified by lightweight node computing device 250B for executing smart contract operation network function request 290. After the new block has been added to blockchain 226, smart contract operation request 290 may be considered to be executed and the data transfer from the wallet associated with lightweight node computing device 250B to the public key associated with the smart contract may be registered.

The smart contract may be configured to hold the data transfer from the wallet associated with lightweight node computing device 250B until fulfillment of certain predetermined criteria hardcoded into the smart contract are achieved. The smart contract may be configured such that it serves as an intermediate arbiter between entities within the decentralized P2P network 270 and may specify details of a dual data transfer between entities.

For example, the smart contract corresponding to smart contract operation request 290 may be one or more algorithms and/or programs stored on a block of blockchain 226. The smart contract may be identified by one or more wallets and/or public keys within decentralized P2P network 270. Lightweight node computing device 250B may transmit smart contract operation network function request 290 to decentralized P2P network 270, which may cause execution of the corresponding smart contract that facilitates a dual data transfer between a wallet associated with lightweight node computing device 250B and a wallet associated with another node in decentralized P2P network 270, such as lightweight node computing device 250A, based on fulfillment of programmatic conditions established by the smart contract. In the processes of adding the block comprising smart contract operation request 290 to blockchain 226, each of full node computing devices 210A-210F may identify the block within blockchain 226 comprising the smart contract, associate the data transfer entailed by smart contract operation request 290 with the smart contract, and execute the one or more algorithms and/or programs of the smart contract. In this instance, given that the smart contract facilitates a dual data transfer and that data transfer has yet to be received from another node (e.g., lightweight node computing device 250A), each of full node computing devices 210A-210F may execute the smart contract without fulfillment of the programmatic conditions established by the smart contract. Accordingly, the funds transferred by lightweight node computing device 250B may remain in the smart contract until the data transfer from the other node is also associated with the smart contract.

Moving forward, lightweight node computing device 250A may also request a smart contract operation related to decentralized P2P network 270, which may conclude the dual data transfer between the wallet associated lightweight node computing device 250A and the wallet associated with lightweight node computing device 250B. Processors of lightweight node computing device 250A may execute network commands to broadcast the smart contract operation network function request to decentralized P2P network 270. The smart contract operation network function request may include details about the data transfer such as data type and amount, as well as a data transfer amount to full node computing devices 210A-210F of decentralized P2P network 270 for executing the smart contract corresponding to the smart contract operation network function request. The smart contract operation network function request may further include the public key associated with the smart contract. Processors of lightweight node computing device 250A may execute digital signature algorithms to digitally sign the smart contract operation network function request with the private key associated with the wallet of lightweight node computing device 250A.

At decentralized P2P network 270, the smart contract operation network function request may be broadcasted to each of full node computing devices 210A-210F through execution of network protocols by full node computing devices 210A-210F. In order to execute the smart contract operation network function request and maintain inter-nodal agreement as to the state of blockchain 226, processors, ASIC devices, and/or GPUs of full node computing devices 210A-210F may execute network protocols to receive broadcast of the network function through a decentralized P2P network 270 and from lightweight node computing device 250A. Processors, ASIC devices, and/or GPUs of full node computing devices 210A-210F may execute hash functions to generate a digest of the smart contract operation network function request. The resultant digest of the smart contract operation network function request, in turn, may be hashed with the block hash of the most immediately preceding block of blockchain 226. Processors, ASIC devices, and/or GPUs of full node computing devices 210A-210F may execute consensus algorithms to identify a nonce corresponding to the particular executed consensus algorithm and related to the digest that combines the digest of the smart contract operation network function request and the block hash of the most immediately preceding block of blockchain 226.

The identification of the nonce enables processors, ASIC devices, and/or GPUs of the full node computing device from full node computing devices 210A-210F to create a new block with a block header (e.g., block hash), which is a digest that combines the smart contract operation network function request, the block hash of the most immediately preceding block, and the identified nonce. Processors, ASIC devices, and/or GPUs of the full node computing device from full node computing devices 210A-210F may execute network protocols to add the new block to blockchain 226 and broadcast the new block to the other full node computing devices in the decentralized P2P network 270. In some arrangements, the new block may also be time-stamped at a time corresponding to the addition to blockchain 226. Furthermore, as a reward for adding the new block to blockchain 226, the full node computing device from full node computing devices 210A-210F may be allowed, per the network protocols, to increase a balance sheet holdings amount associated with itself by a predetermined amount. In some arrangements, each of full node computing devices 210A-210F may receive an equal portion of the data transfer amount specified by lightweight node computing device 250A for executing the smart contract operation network function request. After the new block has been added to blockchain 226, the smart contract operation transaction network function request 290 may be considered to be executed and the data transfer from the wallet associated with lightweight node computing device 250A to the public key associated with the smart contract may be registered.

When the smart contract receives the data value from each of lightweight node computing device 250A and lightweight node computing device 250B, the execution of the smart contract by each of full node computing devices 210A-210F may cause transfer of the data value from lightweight node computing device 250A to lightweight node computing device 250B and the data value from lightweight node computing device 250B to lightweight node computing device 250A.

For example, lightweight node computing device 250A may transmit the smart contract operation network function request to decentralized P2P network 270, which may cause execution of the corresponding smart contract that facilitates the dual data transfer. In the process of adding the block comprising the smart contract operation request provided by lightweight node computing device 250A to blockchain 226, each of full node computing devices 210A-210F may identify the block within blockchain 226 comprising the smart contract, associate the data transfer entailed by smart contract operation request of lightweight node computing device 250A with the smart contract, and execute the one or more algorithms and/or programs of the smart contract. In this instance, given that the smart contract facilitates a dual data transfer and that data transfers have been received from lightweight node computing device 250A and lightweight node computing device 250B, each of full node computing devices 210A-210F may execute the smart contract as fulfillment of the programmatic conditions established by the smart contract has occurred. Accordingly, the funds allocated to the smart contract by each of lightweight node computing device 250A and lightweight node computing device 250B may be respectively distributed to the intended counterparty.

While the description provided above was made in relation to lightweight node computing device 250A and lightweight node computing device 250B, it should be understood that any of the full node computing devices and lightweight node computing devices in decentralized system 200 may participate in the smart contract. Furthermore, it should be understood that the smart contract may be able to fulfill dual data transfers in the manner described above across a plurality of entities entering into the smart contract. For example, a first plurality of entities may enter into the smart contract, which may hold the data values for each of the first plurality of entities until a second plurality of entities enter into the smart contract. When each of the first plurality of entities and the second plurality of entities have entered, the smart contract may perform the data transfer. Other smart contracts may be included which include algorithms, programs, and/or computer-executable instructions which cause the performance of one or more functions related to at least cryptocurrency, digital content storage and delivery, entity authentication and authorization, digital identity, marketplace creation and operation, internet of things (e.g., IoT), prediction platforms, election records, currency exchange and remittance, P2P transfers, ride sharing, trading platforms, and real estate, precious metal, and work of art registration and transference.

In comparison to the centralized computing system 100 described in regard to FIG. 1, decentralized P2P computer system 200 may provide technological advantages. For example, by distributing storage of blockchain 226 across multiple full node computing devices 210A-210F, decentralized P2P computer system 200 may not provide a single point of failure for malicious attack. In the event that any of the full node computing devices 210A-210F are compromised by a malicious attacker, decentralized P2P computer system 200 may continue to operate unabated as data storage of blockchain 226 and performance of network processes are not controlled by a singular entity such as server infrastructure 110 of centralized computing system 100.

Furthermore, by utilizing blockchain data structure 226, decentralized P2P system 200 may provide technological improvements to conventional decentralized P2P systems in regard to byzantine fault tolerance stemming from an unreliable and/or malicious full node acting in decentralized P2P network 270 to undermine the work efforts of the other nodes. For example, in coordinating action between full node computing devices 210A-210F in relation to a similar computational task (e.g., consensus algorithm), a malicious node would need to have computational power greater than the combined computational power of each of the other full node computing devices in decentralized P2P network 270 to identify the nonce and thereby be able to modify blockchain 226. As such, the likelihood that a malicious node could subvert decentralized P2P network 270 and enter falsified data into blockchain 226 is inversely proportional to the total computational power of decentralized P2P system 200. Therefore, the greater the total computational power of decentralized P2P system 200, the less likely that a malicious node could subvert decentralized P2P network 270 and undermine blockchain 226.

FIG. 3A depicts an illustrative example of a full node computing device 210 that may be used in accordance with one or more illustrative aspects described herein. Full node computing device 210 may be any of a personal computer, server computer, hand-held or laptop device, multiprocessor system, microprocessor-based system, set top box, programmable consumer electronic device, network personal computer, minicomputer, mainframe computer, distributed computing environment, virtual computing device, and the like and may operate in a decentralized P2P network. In some embodiments, full node computing device 210 may be configured to operate in a decentralized P2P network and may request execution of network functions and/or to execute requested network functions and maintain inter-nodal agreement as to the state of a blockchain of the decentralized P2P network.

Full node computing device 210 may include one or more processors 211, which control overall operation, at least in part, of full node computing device 210. Full node computing device 210 may further include random access memory (RAM) 213, read only memory (ROM) 214, network interface 212, input/output interfaces 215 (e.g., keyboard, mouse, display, printer, and the like), and memory 220. Input/output (I/O) 215 may include a variety of interface units and drives for reading, writing, displaying, and/or printing data or files. In some arrangements, full node computing device 210 may further comprise specialized hardware components such as application-specific integrated circuit (e.g., ASIC) devices 216 and/or graphics processing units (e.g., GPUs) 217. Such specialized hardware components may be used by full node computing device 210 in performing one or more of the processes involved in the execution of requested network functions and maintenance of inter-nodal agreement as to the state of a blockchain. Full node computing device 210 may further store in memory 220 operating system software for controlling overall operation of the full node computing device 210, control logic for instructing full node computing device 210 to perform aspects described herein, and other application software providing secondary, support, and/or other functionality which may or might not be used in conjunction with aspects described herein.

Memory 220 may also store data and/or computer executable instructions used in performance of one or more aspects described herein. For example, memory 220 may store digital signature information 221 and one or more hash functions 222, consensus algorithms 223, network protocols 224, and network commands 225. In some arrangements, digital signature information 221, hash functions 222, and/or network commands 225 may comprise a wallet of full node computing device 210. Memory 220 may further store blockchain 226. Each of digital signature information 221, hash functions 222, consensus algorithms 223, network protocols 224, and network commands 225 may be used and/or executed by one or more processors 211, ASIC devices 216, and/or GPUs 217 of full node computing device 210 to create and maintain a decentralized P2P network, request execution of network functions, and/or execute requested network functions and maintain inter-nodal agreement as to the state of blockchain 226.

For example, in order to create and maintain a decentralized P2P network, processors 211, ASIC devices 216, and/or GPUs 217 of full node computing device 210 may execute network protocols 225. Execution of network protocols 225 may cause full node computing device 210 to form a communicative arrangement with other full node computing devices and thereby create a decentralized P2P network. Furthermore, the execution of network protocols 225 may cause full node computing device 210 to maintain the decentralized P2P network through the performance of computational tasks related to the execution of network requests related to a blockchain such as blockchain 226. As will be described in detail below, the execution of such computational tasks (e.g., hash functions 222, consensus algorithms 223, and the like) may cause full node computing device 210 to maintain inter-nodal agreement as to the state of a blockchain with other full node computing devices comprising the decentralized P2P network.

In order to request execution of network functions, such as smart contract operations, processors 211, ASIC devices 216, and/or GPUs 217 of full node computing device 210 may execute network commands 225 to broadcast the network function to a decentralized P2P network comprising a plurality of full nodes and/or lightweight nodes. The request may be digitally signed by full node computing device 210 with usage of the private/public key information and through execution of the digital signature algorithms of digital signature information 221.

In order to execute requested network functions and maintain inter-nodal agreement as to the state of a blockchain, processors 211, ASIC devices 216, and/or GPUs 217 of full node computing device 210 may execute network protocols 224 to receive a broadcast of a requested network function through a decentralized P2P network and from a requesting entity such as a full node or lightweight node. Processors 211, ASIC devices 216, and/or GPUs 217 of full node computing device 210 may execute hash functions 222 to generate a digest of the requested network function. The resultant digest of the requested network function, in turn, may be hashed with the block hash of the most immediately preceding block of the blockchain. As will be described in further detail below, processors 211, ASIC devices 216, and/or GPUs 217 of full node computing device 210 may execute consensus algorithms 223 to identify a numerical value (e.g., nonce) corresponding to the particular executed consensus algorithm and related to the digest that combines the digest of the requested network function and the block hash of the most immediately preceding block of the blockchain. The identification of the numerical value enables processors 211, ASIC devices 216, and/or GPUs 217 of full node computing device 210 to create a new block with a block header (e.g., block hash), which is a digest that combines the digest of the requested network function, the block hash of the most immediately preceding block, and the identified nonce. Processors 211, ASIC devices 216, and/or GPUs 217 of full node computing device 210 may add the new block to the blockchain based on network protocols 224 and broadcast the new block to the other nodes in the decentralized P2P network.

As stated above, in some arrangements, a plurality of network function requests may be broadcasted across the decentralized P2P network. Processors 211, ASIC devices 216, and/or GPUs 217 of full node computing device 210 may execute network protocols 224 to receive broadcast of each of the network functions through the decentralized P2P network and from the requesting entities. Processors 211, ASIC devices 216, and/or GPUs 217 of full node computing device 210 may execute hash functions 222 to generate a hash tree (e.g., Merkle tree) of the requested network functions, which culminates in a single digest (e.g., root digest, root hash, and the like) that comprises the digests of each of the requested network functions. The root digest of the requested network function, in turn, may be hashed with the block hash of the most immediately preceding block of the blockchain. Processors 211. ASIC devices 216, and/or GPUs 217 of full node computing device 210 may execute consensus algorithms 223 to identify a numerical value (e.g., nonce) corresponding to the particular executed consensus algorithm and related to the digest that combines the root digest of the requested network functions and the block hash of the most immediately preceding block of the blockchain. The identification of the numerical value enables processors 211, ASIC devices 216, and/or GPUs 217 of full node computing device 210 to create a new block with a block header (e.g., block hash), which is a digest that combines the root digest of the requested network functions, the block hash of the most immediately preceding block, and the identified nonce. Processors 211, ASIC devices 216, and/or GPUs 217 of full node computing device 210 may add the new block to the blockchain based on network protocols 224 and broadcast the new block to the other nodes in the decentralized P2P network.

Furthermore, memory 220 of full node computing device 210 may store blockchain 226. Blockchain 226 may include a blocks 227A, 227B, 227C . . . 227n, wherein block 227A represents the first block (e.g., genesis block) of blockchain 226 and block 227n represents the most immediate block of blockchain 226. As such, the blockchain 226, which may be a replica or copy of the blockchain of the decentralized P2P network in which full node computing device 210 operates, may be a full or complete copy of the blockchain of the decentralized P2P network. Each of the blocks within blockchain 226 may include information corresponding to the one or more network functions executed by the decentralized P2P network. As such, blockchain 226 as stored in memory 220 of full node computing device 210 may comprise the totality of network functions executed by the decentralized network.

FIG. 3B depicts an illustrative example of a lightweight node computing device 250 that may be used in accordance with one or more illustrative aspects described herein. Lightweight node computing device 250 may be any of a personal computer, server computer, hand-held or laptop device, multiprocessor system, microprocessor-based system, set top box, programmable consumer electronic device, network personal computer, minicomputer, mainframe computer, distributed computing environment, virtual computing device, and the like and may operate in a decentralized P2P network. In some embodiments, lightweight node computing device 250 may operate in a decentralized P2P network and may be configured to request execution of network functions through the decentralized P2P network. As such, lightweight node computing device 250 may be different than full node computing device 210 in that it is not configured to execute network functions and/or operate to maintain a blockchain of a decentralized P2P network. In other aspects, lightweight node computing device 250 may have substantially the same physical configuration as full node computing device 210, but configured with different programs, software, and the like.

Lightweight node computing device 250 may include one or more processors 251, which control overall operation of lightweight node computing device 250. Lightweight node computing device 250 may further include random access memory (RAM) 253, read only memory (ROM) 254, network interface 252, input/output interfaces 255 (e.g., keyboard, mouse, display, printer, and the like), and memory 260. Input/output (I/O) 255 may include a variety of interface units and drives for reading, writing, displaying, and/or printing data or files. Lightweight node computing device 250 may store in memory 260 operating system software for controlling overall operation of the lightweight node computing device 250, control logic for instructing lightweight node computing device 250 to perform aspects described herein, and other application software providing secondary, support, and/or other functionality which may or might not be used in conjunction with aspects described herein.

In comparison to full node computing device 210, lightweight node computing device 250 might not include, in some instances, specialized hardware such as ASIC devices 216 and/or GPUs 217. Such is the case because lightweight node computing device 250 might not be configured to execute network functions and/or operate to maintain a blockchain of a decentralized P2P network as is full node computing device 210. However, in certain arrangements, lightweight node computing device 250 may include such specialized hardware.

Memory 260 of lightweight node computing device 250 may also store data and/or computer executable instructions used in performance of one or more aspects described herein. For example, memory 260 may store digital signature information 261 and one or more hash functions 222 and network commands 225. In some arrangements, digital signature information 261, hash functions 222, and/or network commands 225 may comprise a wallet of lightweight node computing device 250. Each of hash functions 222 and network commands 225 stored in memory 260 of lightweight node computing device 250 may be respectively similar and/or identical to hash functions 222 network commands 225 stored in memory 220 of full node computing device 210.

In regard to the digital signature information, each of digital signature information 261 stored in memory 260 of lightweight node computing device 250 and digital signature information 221 stored in memory 220 of full node computing device 210 may comprise similar and/or identical digital signature algorithms. However, the private/public key information of digital signature information 261 stored in memory 260 of lightweight node computing device 250 may be different than that of the private/public key information of digital signature information 221 stored in memory 220 of full node computing device 210. Furthermore, the private/public key information of each node, whether full or lightweight, in a decentralized P2P computing network may be unique to that particular node. For example, a first node in a decentralized P2P computing network may have first private/public key information, a second node may have second private/public key information, a third node may have third private/public key information, and so on, wherein each of the private/public key information is unique to the particular node. As such, the private/public key information may serve as a unique identifier for the nodes in a decentralized P2P computing network.

Each of digital signature information 261, hash functions 222, and network commands 225 may be used and/or executed by one or more processors 251 of lightweight node computing device 250 to request execution of network functions in a decentralized P2P network. For example, in order to request execution of network functions, such as smart contract operations, processors 251 of lightweight node computing device 250 may execute network commands 225 to broadcast the network function to a decentralized P2P network comprising a plurality of full nodes and/or lightweight nodes. The request may be digitally signed by lightweight node computing device 250 with usage of the private/public key information and through execution of the digital signature algorithms of digital signature information 261.

Furthermore, memory 260 of lightweight node computing device 250 may store blockchain 226. Blockchain 226 stored in memory 260 of lightweight node computing device 250 may include at least block 227n, wherein block 227n represents the most immediate block of blockchain 226. As such, the blockchain 226, which may be a replica or copy of the blockchain of the decentralized P2P network in which lightweight node computing device 250 operates, may be a partial or incomplete copy of the blockchain of the decentralized P2P network. In some instances, however, blockchain 226 may include a blocks 227A, 227B, 227C . . . 227n, wherein block 227A represents the first block (e.g., genesis block) of blockchain 226 and block 227n represents the most immediate block of blockchain 226. As such, the blockchain 226 may be a full or complete copy of the blockchain of the decentralized P2P network. Each of the blocks within blockchain 226 may include information corresponding to the one or more network functions executed by the decentralized P2P network.

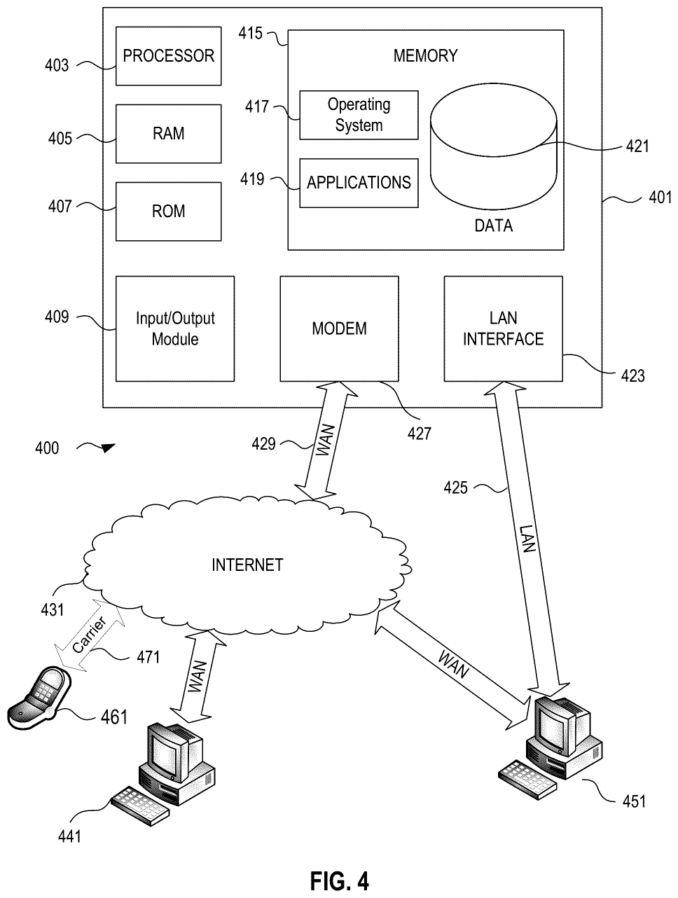

FIG. 4 illustrates an example of a computing system environment 400 that may be used according to one or more illustrative embodiments. The computing system environment 400 is only one example of a suitable computing environment and is not intended to suggest any limitation as to the scope of use or functionality contained in the disclosure. The computing system environment 400 should not be interpreted as having any dependency or requirement relating to any one or combination of components shown in the computing system environment 400.

The disclosure is operational with numerous other general purpose or special purpose computing system environments or configurations. Examples of well known computing systems, environments, and/or configurations that may be suitable for use with the disclosed embodiments include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 4, the computing system environment 400 may include a computing device 401 wherein the processes discussed herein may be implemented. The computing device 401 may have a processor 403 for controlling overall operation of the computing device 401 and its associated components, including random-access memory (RAM) 405, read-only memory (ROM) 407, input/output module or communications module 409, and memory 415. Computing device 401 typically includes a variety of computer readable media. Computer readable media may be any available media that may be accessed by computing device 401 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 401.

Communication media typically embodies computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 400 may also include optical scanners (not shown). Exemplary usages include scanning and converting paper documents, e.g., correspondence, receipts to digital files.

Although not shown, RAM 405 may include one or more applications representing the application data stored in RAM 405, while the computing device is on and corresponding software applications (e.g., software tasks) are running on the computing device 401.

Communications module 409 may include a microphone, keypad, touch screen, and/or stylus through which a user of computing device 401 may provide input, and may also include one or more of a speaker for providing audio output and a video display device for providing textual, audiovisual and/or graphical output.

Software may be stored within memory 415 and/or storage to provide instructions to processor 403 for enabling computing device 401 to perform various functions. For example, memory 415 may store software used by the computing device 401, such as an operating system 417, application programs 419, and an associated database 421. Also, some or all of the computer executable instructions for computing device 401 may be embodied in hardware or firmware.

Computing device 401 may operate in a networked environment supporting connections to one or more remote computing devices, such as computing devices 441, 451, and 461. The computing devices 441, 451, and 461 may be personal computing devices or servers that include many or all of the elements described above relative to the computing device 401. Computing device 461 may be a mobile device communicating over wireless carrier channel 471.

The network connections depicted in FIG. 4 include a local area network (LAN) 425 and a wide area network (WAN) 429, but may also include other networks. When used in a LAN networking environment, computing device 401 may be connected to the LAN 425 through a network interface, such as LAN interface 423, or to an adapter in the communications module 409. When used in a WAN networking environment, the computing device 401 may include a modem in the communications module 409, a modem separate from the communications module 409, such as modem 427, or other means for establishing communications over the WAN 429, such as the Internet 431 or other type of computer network. It will be appreciated that the network connections shown are illustrative and other means of establishing a communication link between the computing devices may be used. Various well-known protocols such as TCP/IP, Ethernet, FTP, HTTP and the like may be used, and the system can be operated in a client-server or in Distributed Computing configuration to permit a user to retrieve web pages from a web-based server. Any of various conventional web browsers can be used to display and manipulate data on web pages.

Additionally, one or more application programs 419 used by the computing device 401, according to an illustrative embodiment, may include computer executable instructions for invoking user functionality related to communication including, for example, email, short message service (SMS), and voice input and speech recognition applications.

Embodiments of the disclosure may include forms of computer-readable media. Computer-readable media include any available media that can be accessed by a computing device 401. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on a computing device 401. Such a processor may execute computer-executable instructions stored on a computer-readable medium. In an example, the systems and apparatus described herein may correspond to the computing device 401. A computer-readable medium (e.g., ROM 407) may store instructions that, when executed by the processor 403, may cause the computing device 401 to perform the functions as described herein.

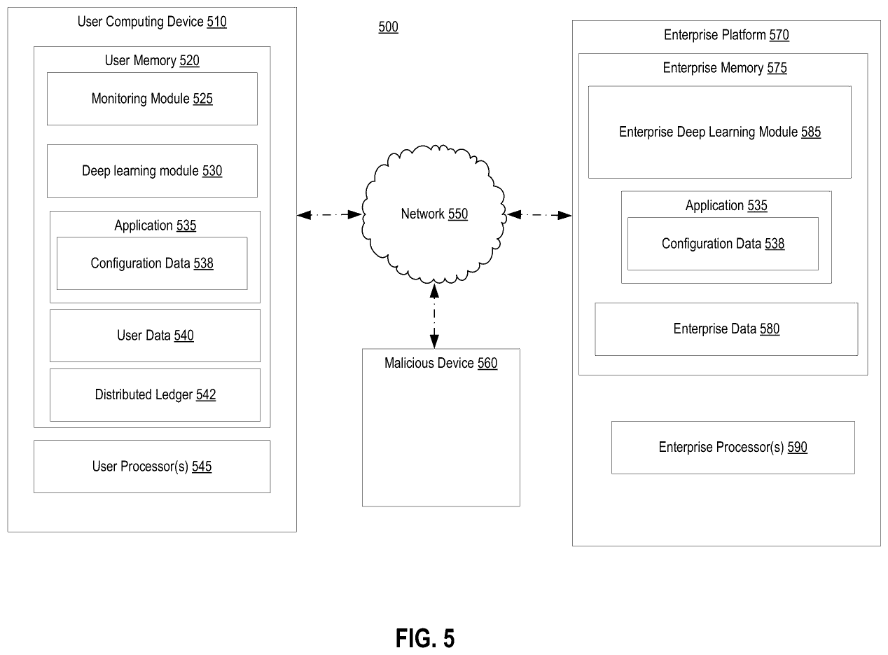

FIG. 5 illustrates an example computing environment 500 that may be used in accordance with one or more illustrative aspects described herein. The computing environment 500 may comprise a user computing device 510, a malicious device 560, and an enterprise platform 570 that communicate through a network 550. The network 550 may be a private and/or public network. The user computing device 510 may comprise a user memory 520 and one or more user processor(s) 545. The user memory 520 may store a monitoring module 525, a deep learning module 530, an application 535, configuration data 538, user data 540, a distributed ledger 542, and/or computer readable instructions, that when executed by the user processor(s) 545, perform one or more functions and/or operations described herein. The application 535 may comprise configuration data 538 associated with the application. In some embodiments, the configuration data 538 associated with the application 535 comprises one or more data associated with the application's settings, such as the version of the application, the security protocol (HTTPS or the like) used by the application, the operating system required to use the application, and/or dates of updates to the version of the application. In some embodiments, the configuration data comprises one or more data of hash keys obtained from hashing executable files of the application 535, encryption keys obtained from encrypting files and data associated with the application 535, and/or an application session identification data (ID) generated for each application session. The user computing device may comprise a smart phone, tablet, smart watch, and/or a laptop and the like.

The enterprise platform 570 may comprise an enterprise memory 575 and one or more enterprise processor(s) 590. The enterprise memory 575 may store an enterprise deep learning module 585, an application 535, configuration data 538, enterprise data 580, and/or computer readable instructions, that when executed by the enterprise processor(s) 590, perform one or more functions and/or operations described herein.

In some embodiments, the monitoring module 525 is used to generate a smart contract for monitoring an application session associated with the application 535. The application 535 may be used to communicate and/or transfer information, transactions, and/or other events between the enterprise platform 570 and the user computing device 510. For example, once an application session complies with rules assigned to the smart contract, the enterprise platform 575 may send enterprise data 580 to the user computing device 510 representing past transactions, account information, and/or other information and the like associated with an enterprise organization and/or a customer. The user data 540 may comprise password information, transaction information, location information, and/or personal information (e.g., a customer's name, a customer's address, a customer's account number, a customer's unique identification number, a customer's phone number and the like) associated with the user computing device 510. The monitoring module 525 may also comprise a rules engine for dynamically determining rules for the smart contract. In some examples, the rules engine may periodically update rules for a smart contract based on updates to the configuration data 538 associated with the application 535. The configuration data 538 associated with the application 535 may be updated when a new version of the application 535 is downloaded and/or stored in the user memory 520 on the user computing device 510. In another example, the application 535 and its associated configuration data 538 is updated based on updated configuration data sent from the enterprise platform 570 and received by the user computing device 510.

Every time the application 535 initiates or launches an application session on the user computing device 510, a smart contract is generated, assigned rules, and bound with the configuration data 538 to monitor or authenticate the application session to prevent any misconfigured data or potentially malicious code in the configuration data from executing. The smart contract protects against malicious attacks at the application level that may cause personal user data and/or an enterprise organization's enterprise data 580 from being compromised.

In some embodiments, the monitoring module 525 generates a smart contract for monitoring an application session based on dynamic rules or logic that may be determined from a rules engine and/or the deep learning module 530. Each time an application session associated with the application 535 is initiated, the monitoring module 525 generates a smart contract, assigns rules to the smart contract, and binds the configuration data 538 with the smart contract. The rules may include a first rule for the smart contract related to denying permission to the application session when the application session attempts to execute by bypassing the smart contract, a second rule for the smart contract related to denying permission to the application session when unknown data not associated with the application 535 is detected in the configuration data 538 associated with the application 535, and a third rule for the smart contract related to shutting down the application session when a malicious indication is detected in the configuration data 538. In some examples, the malicious indication is determined by processing the configuration data 538 by the deep learning module 530, which outputs the malicious indication. The first rule and second rule may dynamically update by the rules engine. In some examples, the malicious indication is related to specific vulnerabilities associated with the application. The unknown data may be malware data or virus data that execute malicious requests.

In some embodiments, after the smart contract is generated and assigned the first, second and third rules, the monitoring module 525 may extract the configuration data 538 and bind the configuration data 538 with the smart contract. Then, the smart contract is added to the distributed ledger 542 for monitoring the application session. The smart contract denies or grants the application session permission to access user data 540 based on the rules assigned to the smart contract. The smart contract protects against malicious attacks or requests by the malicious device 560 attempting to tamper with misconfigurations in the configuration data 538 associated with the application 535.

The distributed ledger 542 may be a public or private blockchain that stores records related to smart contracts bound with configuration data 538 for monitoring applications sessions associated with the application 535. In some embodiments, the distributed ledger 542 stores a plurality of historical smart contracts each bound with one of a plurality of historical configuration data from a plurality of historical application sessions initiated and/or executed by the application 535. The plurality of historical configuration data is associated with historical versions of the application 535. The user computing device 510 may serve as a computer node in a decentralized P2P network for storing, managing, and/or performing smart contract operations on the distributed ledger 542 related to monitoring application sessions initiated and/or executed by the user computing device 510.

The deep learning module 530 may comprise input layers, training layers, and malicious output layers for determining a malicious indication. The malicious indication indicates if an application session is attempting to execute malicious requests. The deep learning module 530 may train on a plurality of historical configuration data associated with historical versions of the application 535. In some embodiments, the deep learning module 530 is a convolutional neural network. In some embodiments, the plurality of historical configuration data is stored on the distributed ledger and is extracted from a plurality of smart contracts each bound with one of the plurality of historical configuration data from a plurality of historical application sessions. The deep learning module 530 may be part of a transferred learning model system that also includes the enterprise deep learning module 585. In the transferred learning model system, the deep learning module 530 transfers certain layers, which may be the input layers and at least some of the training layers, to the enterprise deep learning module 585. The enterprise deep learning module 585 adds the input layers and at least some of the training layers from the deep learning module 530. The enterprise deep learning module 585 may comprise input layers, training layers, and misconfiguration output layers used to determine a misconfiguration indication. The misconfiguration indication indicates if the configuration data 538 is misconfigured. By adding some of the input layers and at least some of the training layers, the enterprise deep learning module 585 reuses the layers to conserve resources by not having to train the enterprise deep learning module 585 on a new set of data, e.g., the configuration data 538 and/or historical configuration data from historical application sessions. In some embodiments, the enterprise deep learning module 585 also receives input layers and training layers from a plurality of deep learning modules on a plurality of user computing devices through the network 550 in order to optimize the enterprise deep learning module 585.

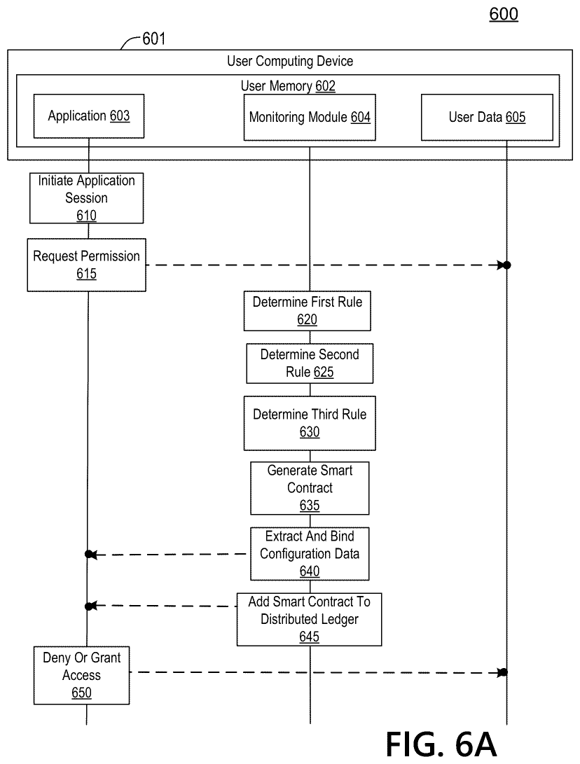

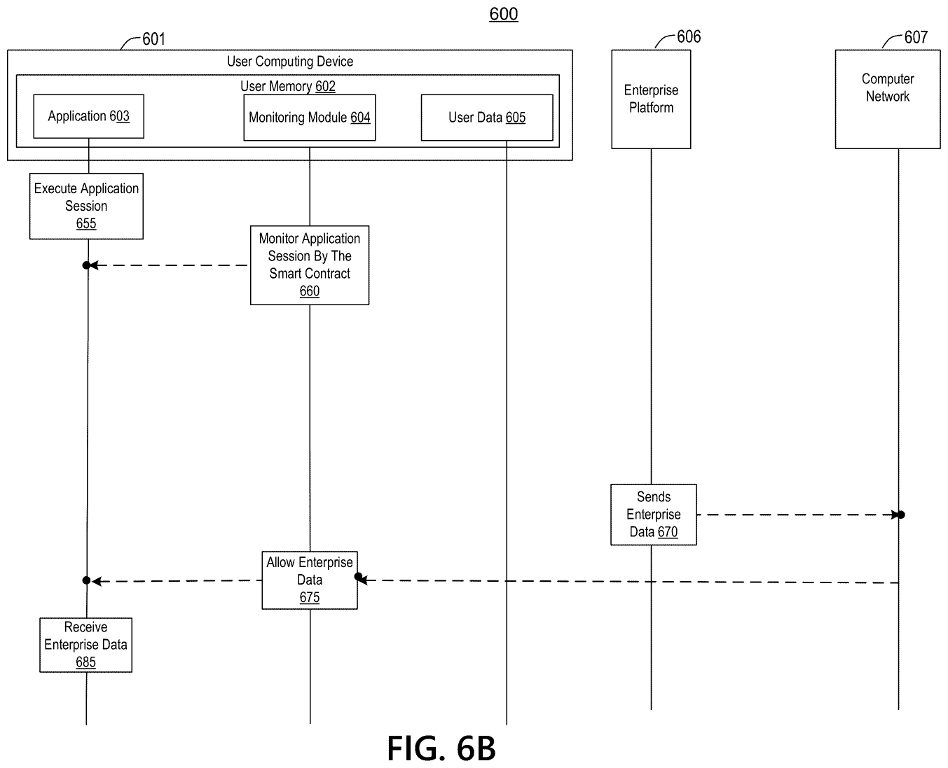

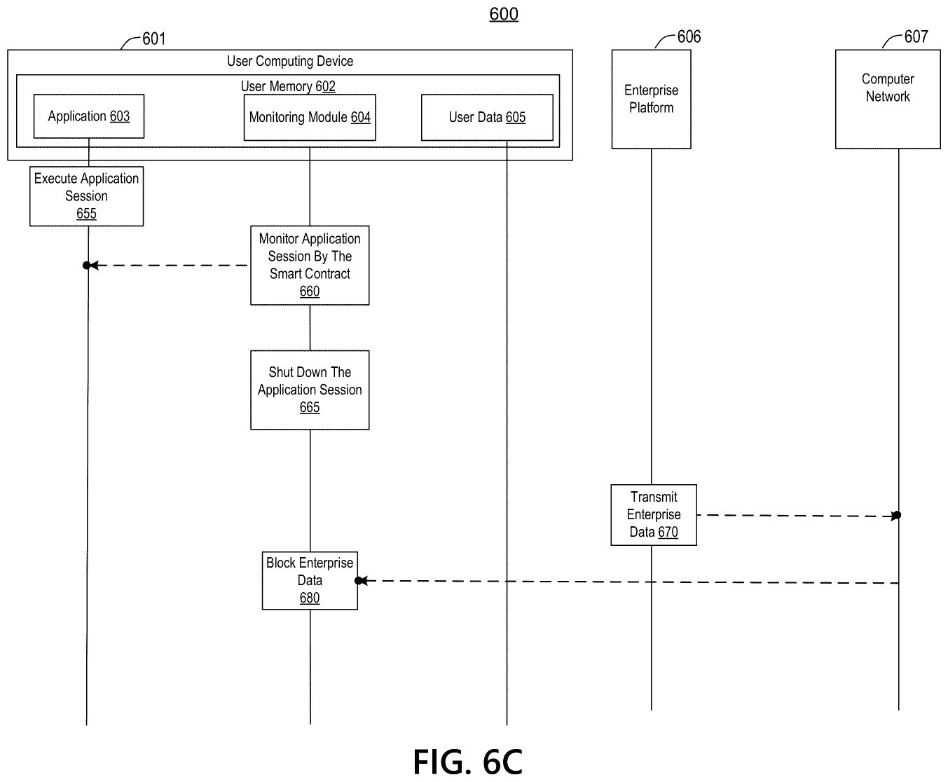

FIG. 6A depicts an illustrative event sequence 600 that may be used in accordance with one or more illustrative aspects described herein. The steps of the event sequence may be performed by a system comprising a user computing device 601. The user computing device 601 may comprise a user memory 602 storing an application 603, a monitoring module 604, and user data 605.

At step 610, the user computing device 601 initiates an application session associated with the application 603. At step 615, the application session requests permission to access user data 605. At step 620, a first rule is determined for a smart contract related to denying permission to the application session when the application session attempts to execute by bypassing the smart contract. At step 625, a second rule is determined for the smart contract related to denying permission to the application session when unknown data not associated with the application is detected in configuration data associated with the application. The first and second rules may be dynamically updated and/or determined by a rules engine. At step 630, a third rule is determined for the smart contract related to shutting down the application session when a malicious indication is detected in the configuration data. The malicious indication may be determined and output by a deep learning module in the user memory. At step 635, the monitoring module generates the smart contract assigned the first rule, second rule, and third rule. At step 640, the monitoring module extracts configuration data associated with the application 603 and binds the smart contract with the configuration data. At step 645, the smart contract is added to a distributed ledger for monitoring the application session. At step 650, the smart contract denies or grants the application session permission to access user data 605 based on the rules assigned to the smart contract.

FIG. 6B depicts an illustrative event sequence 600 that may be used in accordance with one or more illustrative aspects described herein. The system for performing the steps of the event sequence may further comprise an enterprise platform 606.

At step 655, the user computing device 601 executes the application session when the smart contract grants the application session permission to access user data 605. At step 660, the smart contract monitors the application session executing on the user computing device 601. In one example, the application session complies with the rules of the smart contract during execution of the application session. At step 670, the enterprise platform 606 sends enterprise data to the user computing device 602 through the computer network 607. At step 675, the smart contract allows reception of the enterprise data due to the application session being in compliance with the rules of the smart contract. At step 685, the user computing device receives the enterprise data for use by the application session.

FIG. 6C depicts an illustrative event sequence 600 that may be used in accordance with one or more illustrative aspects described herein. At step 655, the user computing device 601 executes the application session when the smart contract grants the application session permission to access user data 605. At step 660, the smart contract monitors the application session executing on the user computing device 601. In one example, the application session does not comply with the third rule of the smart contract. At step 665, the smart contract shuts down the application session based on the third rule assigned to the smart contract. At step 670, the enterprise platform sends enterprise data to the user computing device 602 through the computer network 607. At step 680, the user computing device 602 blocks from the enterprise data associated with the application received from the enterprise platform.

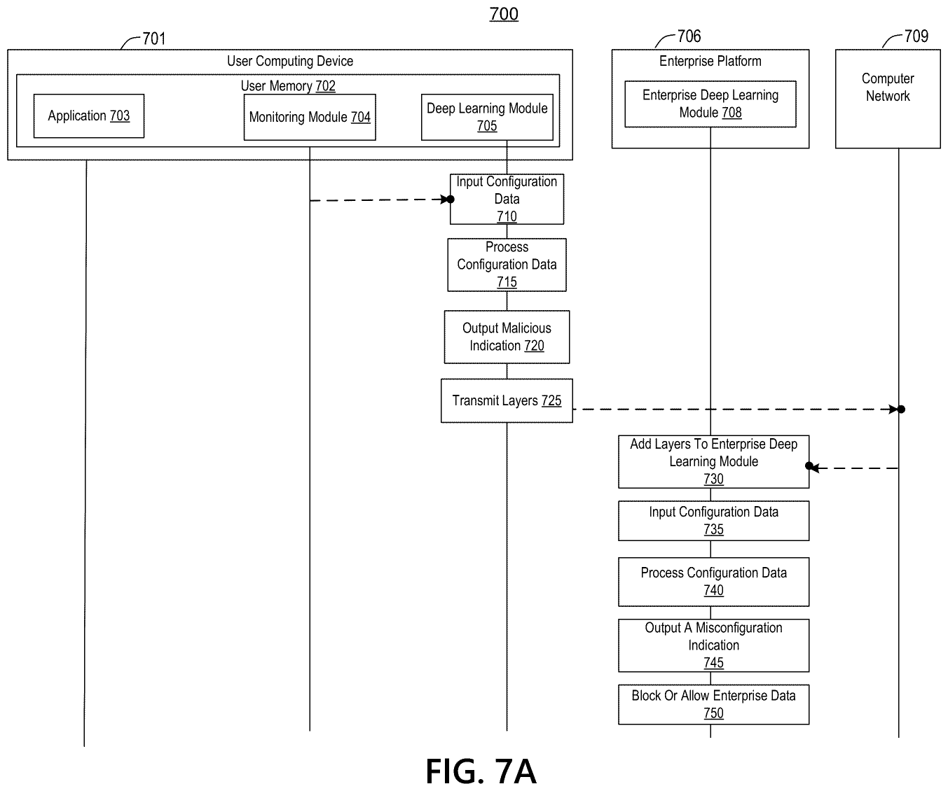

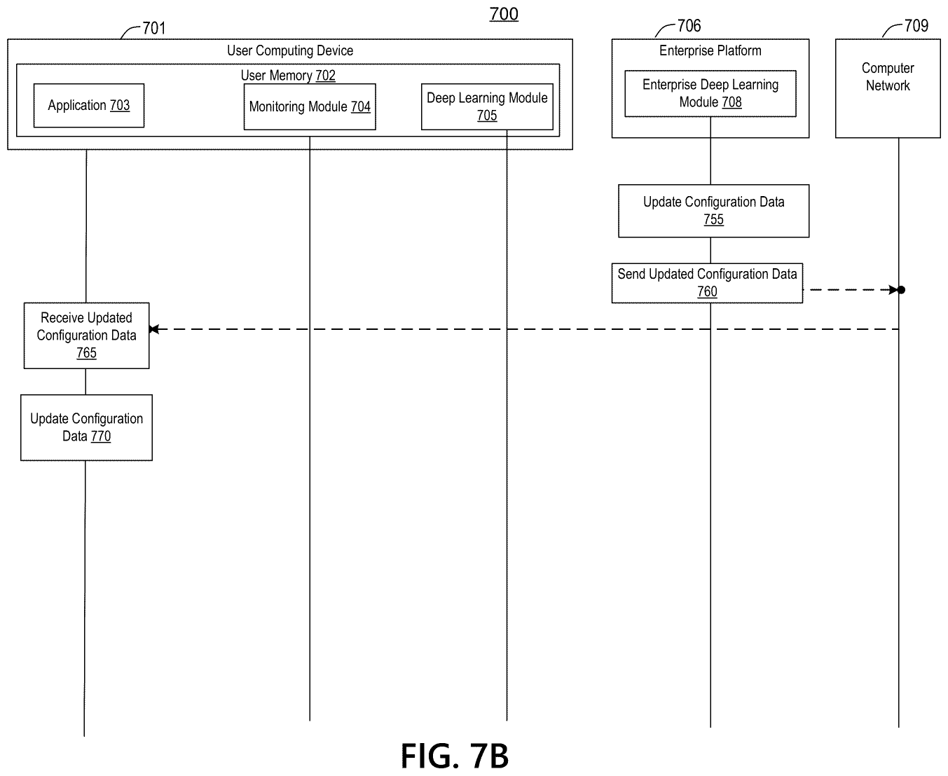

FIG. 7A depicts an illustrative event sequence 700 that may be used in accordance with one or more illustrative aspects described herein. The steps of the event sequence may be performed by a system comprising a user computing device 701 and an enterprise platform 707. The user computing device 701 may comprise a user memory 702 storing an application 703, a monitoring module 704, a deep learning module 705. The enterprise platform 707 may comprise an enterprise deep learning module 708.

At step 710, configuration data associated with the application 703 is input into the deep learning module 705. The deep learning module 705 may comprise input layers, training layers, and malicious output layers. In some embodiments, the deep learning module 705 is a convolutional neural network that is a part of a transferred learning model system that also includes the enterprise deep learning module 708. The deep learning module 705 is trained on historical configuration data. In some embodiments, the historical configuration data is stored on the distributed ledger and is extracted from a plurality of smart contracts each bound with one of a plurality historical configuration data associated with a plurality of historical application sessions. At step 715, the deep learning module 705 processes the configuration data. At step 720, the deep learning module 705 outputs a malicious indication for determining the third rule. The malicious indication indicates if the application session is attempting to execute malicious requests.

At step 725, the user computing device sends the input layers and training layers to the enterprise platform. At step 730, the enterprise platform 706 adds the input layers and training layers to the enterprise deep learning module 708. In some embodiments, the enterprise deep learning module 708 is a convolutional neural network that is a part of a transferred learning model system that includes the deep learning module 705. The enterprise deep learning module 708 may comprise input layers, training layers, and misconfiguration output layers. At step 735, the configuration data is input into the enterprise deep learning module 708. At step 740, the enterprise deep learning module 708 processes the configuration data. At step 745, the enterprise deep learning module 708 outputs a misconfiguration indication indicating if the configuration data is misconfigured. At step 750, the enterprise platform 708 is blocked or allowed from sending the enterprise data to the user computing device based on the misconfiguration indication.

FIG. 7B depicts an illustrative event sequence 700 that may be used in accordance with one or more illustrative aspects described herein. At step 755, the enterprise platform 706 updates the configuration data based on the misconfiguration indication. In some embodiments, the application and the updated configuration data associated with the application are stored in memory of the enterprise platform 706. At step 706, the enterprise platform 706 sends to the user computing device 701, the updated configuration data through the computer network 709. At step 765, the user computing device 701 receives the updated configuration data from the enterprise platform 706. At step 770, the user computing device 701 updates the configuration data based on the updated configuration data.

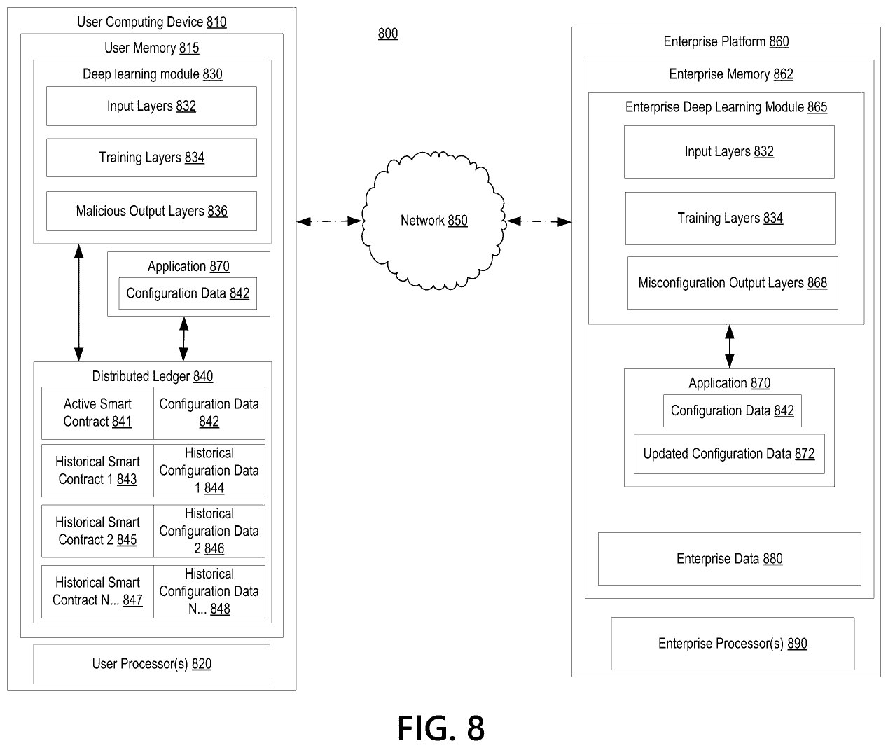

FIG. 8 depicts an example computing environment 800 that may be used in accordance with one or more illustrative aspects described herein. The computing environment 800 may comprise a user computing device 810 and an enterprise platform 860 that communicate through a network 850. The network 850 may be a private and/or public network. The user computing device 810 may comprise a user memory 815 and one or more user processor(s) 820. The user memory 815 may store a deep learning module 830, an application 870, configuration data 842, a distributed ledger 840, and/or computer readable instructions, that when executed by the user processor(s) 820, perform one or more functions and/or operations described herein. The deep learning module 830 may comprise input layers 832, training layers 834, and malicious output layers 836 to determine and/or update a malicious indication indicating whether an application session associated with the application 870 is attempting to execute malicious requests. The malicious indication may dynamically update and/or determine a third rule for the active smart contract 841 related to shutting down an application session when the malicious indication indicates the application session is executing malicious requests. The distributed ledger 840 may store an active smart contract 841 bound with configuration data 842 for monitoring an application session associated with the application 870. In some examples, the distributed ledger also stores a plurality of historical smart contracts each bound with one of a plurality of historical configuration data from a plurality of historical application sessions initiated and/or executed by the application 870. In some embodiments, the distributed ledger stores historical smart contract 1 843 bound with historical configuration data 1 844, historical smart contract 2 845 bound with historical configuration data 2 846, and/or historical smart contract N . . . 847 bound with historical configuration data N . . . and so on.

The enterprise platform 860 may comprise an enterprise memory 862 and one or more enterprise processor(s) 890. The enterprise memory 862 may store an enterprise deep learning module 865, an application 870, configuration data 842, updated configuration data 872, enterprise data 880, and/or computer readable instructions, that when executed by the enterprise processor(s) 890, perform one or more functions and/or operations described herein. The application 870 may comprise configuration data 842 or updated configuration data 872 associated with the application. For example, the enterprise deep learning module 865 may output a misconfiguration indication indicating the configuration data 842 is misconfigured. The enterprise platform 860 may update the configuration data 842 and the associated application 870 to a new version represented by the updated configuration data 872 based on the misconfiguration indication. In some embodiments, the updated configuration data 872 associated with the application 870 comprises one or more data associated with the application's settings, such as the version of the application, the security protocol (HTTPS or the like) used by the application, the operating system required to use the application, and/or dates of updates to the version of the application. In some embodiments, the configuration data comprises one or more data of hash keys obtained from hashing executable files of the application, encryption keys obtained from encrypting files and data associated with the application, and/or an application session identification data (ID) generated for each application session.

The deep learning module 830 is connected by a data bus to the distributed ledger 840. In this example, the deep learning module 830 extracts historical configuration data 1 844, historical configuration data 2 846, historical configuration data N . . . 848 and/or other historical configuration data from the distributed ledger 840. The deep learning module 830 inputs the plurality of historical configuration data for training purposes. The input layers 832 train on the plurality of historical configuration data and as more historical configuration data is input into the deep learning module, more training layers 834 are added to learn correct or compliant code, files, and/or characteristics associated with the plurality of historical configuration data. As the training layers 834 progressively become better at predicting correct or compliant code, files, and/or characteristics associated with the plurality of historical configuration data, the malicious output layers 836 are trained to output a malicious indication indicating whether the plurality of historical configuration data contains correct or compliant code, files, and/or characteristics or if one of the plurality of historical configuration data contains malicious code, files, and/or characteristics. After the deep learning module 830 is trained, the malicious output layers 836 are capable of predicting whether the configuration data 842 bound with the active smart contract 841 is attempting to execute malicious requests. In one example, the configuration data 842 is input into the deep learning module 830. The configuration data 842 is processed by the deep learning module 830. The deep learning module 830 then outputs a malicious indication indicating if the application session executing on the user computing device 810 is attempting to execute malicious requests. The malicious indication output by the deep learning module 830 is then sent to the distributed ledger 840 in order to update and/or determine the third rule to the active smart contract 841 related to shutting down the application session when a malicious indication is detected in the configuration data 842.

In some embodiments, an application session associated with the application 870 is executing on the user computing device 810. The active smart contract 841 bound with configuration data 842 associated with the application 870 is stored on the distributed ledger 840 for monitoring the application session as it executes. The application 870 and its associated configuration data 842 may be connected by a data bus to the active smart contract 841 on the distributed ledger 840, so the active smart contract 841 may shut down the application session if it does not comply with the third rule to the active smart contract 841 determined by the malicious indication.

In another embodiment, the deep learning module 830 may be part of a transferred learning model system that also includes the enterprise deep learning module 865. In the transferred learning model system, the deep learning module 830 transfers certain layers, which may be the input layers 832 and at least some of the training layers 834, to the enterprise deep learning module 865 through the network 850. The enterprise deep learning module 865 adds the input layers 832 and at least some of the training layers 834 from the deep learning module 830. The enterprise deep learning module 865 may comprise input layers 832, training layers 834, and misconfiguration output layers 868 used to determine a misconfiguration indication. By adding some of the input layers 832 and at least some of the training layers 834, the enterprise deep learning module 865 reuses the layers to conserve resources by not having to train the enterprise deep learning module 865 on a new set of data, e.g., the configuration data 842 and/or historical configuration data 844, 846, 848 from historical application sessions. In some embodiments, the enterprise deep learning module 865 also receives input layers and training layers from a plurality of deep learning modules on a plurality of user computing devices through the network 850 in order to optimize the enterprise deep learning module 865. The enterprise deep learning module 865 takes advantage of the transferred layers from the deep learning module 830 by using the already trained layers for a similar task, determining a misconfiguration indication indicating whether the configuration data 842 is misconfigured.

After the input layers 832 and training layers 834 are added to the enterprise deep learning module 865, the configuration data 842 is input into the enterprise deep learning module 865. The enterprise deep learning module 865 processes the configuration data 842. The enterprise deep learning module 865 then outputs from the misconfiguration output layers, a misconfiguration indication indicating whether the configuration data 842 is misconfigured. The enterprise deep learning module 865 may then communicate or send to the application 870, through a data bus, the misconfiguration indication. Based on the misconfiguration indication, the enterprise platform 860 blocks or allows the application 870 from sending the enterprise data 880 to the user computing device 810 based on the misconfiguration indication.

In another embodiment, the enterprise platform 860 updates the configuration data 842 if the misconfiguration indication indicates that the configuration data 842 is misconfigured. The updated configuration data 872 is then stored with the associated application 870 in the enterprise memory 862. The enterprise platform 860 sends the updated configuration data 872 to the user computing device 810. The user computing device 810 updates the configuration data 842 based on the updated configuration data 872.

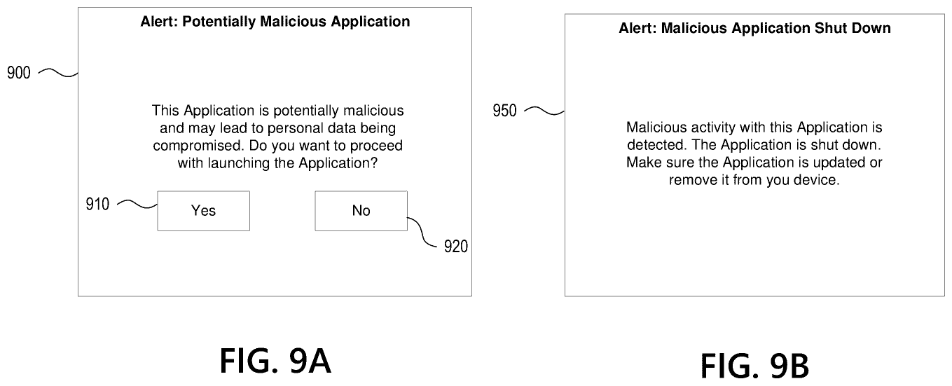

FIG. 9A depicts an example alert message that may be used in accordance with one or more illustrative aspects described herein. The alert message 900 may be displayed on a graphical user interface on the user computing device 510 when the smart contract denies or grants an application session access to user data 540 based on the rules assigned to the smart contract. When the application session is initiated, the “Yes” event button 910 may be selected on the graphical interface of the user computing device 510 to continue execution of the application session on the user computing device 510. The “No” event button 920 may be selected to shut down the application session on the user computing device 510.

FIG. 9B depicts an example alert message that may be used in accordance with one or more illustrative aspects described herein. The alert message 950 may be displayed on a graphical user interface on the user computing device 810 when the application session is shut down by the smart contract based on the third rule assigned to the smart contract.

Although the subject matter has been described in language specific to structural features and/or methodological acts, it is to be understood that the subject matter defined in the disclosure is not necessarily limited to the specific features or acts described above. Rather, the specific features and acts described above are described as example implementations of the following disclosure. One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the disclosure will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed:

1. A system for monitoring an application session associated with an application for malware, a virus, or a malicious indication by a smart contract comprising:
a user computing device comprising:
a processor; and
a memory storing the application, a monitoring module, user data, and computer-readable instructions, that when executed by the processor, cause the user computing device to:
initiate the application session associated with the application, wherein the application session requests permission to access user data;
determine a first rule for a smart contract related to denying permission to the application session based on the application session bypassing the smart contract;
determine a second rule for the smart contract related to denying permission to the application session based on detecting unknown data not associated with the application in configuration data associated with the application, wherein the configuration data comprises a setting of the application, a security protocol used by the application, an application session identification data (ID), and hash keys obtained from hashing executable files associated with the application;
determine a third rule for the smart contract related to shutting down the application session based on detecting a malicious indication in the configuration data;
generate, by the monitoring module, the smart contract assigned the first rule, second rule, and third rule;
extract, by the monitoring module, the configuration data associated with the application;
bind, by the monitoring module, the smart contract with the configuration data;
add the smart contract to a distributed ledger for monitoring the application session;
determine, by the smart contract, the application session does not comply with the rules of the smart contract; and
deny, by the smart contract, the application session permission to access user data.

2. The system of claim 1, wherein the memory stores the computer-readable instructions that, when executed by the processor, cause the user computing device to:
if the smart contract determines that the application session does comply with the rules of the smart contract, then grant, by the smart contract, the application session permission to access user data;
monitor, by the smart contract, the application session executing on the user computing device, wherein the application session does comply with the third rule of the smart contract; and
receive, from an enterprise platform, enterprise data associated with the application.

3. The system of claim 1, wherein the memory stores the computer-readable instructions that, when executed by the processor, cause the user computing device to:
if the smart contract determines that the application session does comply with the rules of the smart contract, then grant, by the smart contract, the application session permission to access user data;
monitor, by the smart contract, the application session executing on the user computing device, wherein the application session does not comply with the third rule of the smart contract;
shut down, by the smart contract, the application session based on the third rule assigned to the smart contract; and
block, from an enterprise platform, enterprise data associated with the application.

4. The system of claim 1, wherein the memory further stores a deep learning module and the computer-readable instructions that, when executed by the processor, cause the user computing device to:
input the configuration data into the deep learning module, wherein the deep learning module comprises input layers, training layers, and malicious output layers;
process, by the deep learning module, the configuration data; and
output, by the deep learning module, a malicious indication for determining the third rule, wherein the malicious indication indicates the application session is executing malicious requests.

5. The system of claim 4, further comprising:
an enterprise platform comprising:
an enterprise processor; and
an enterprise memory storing an application, an enterprise deep learning module, and computer-readable instructions, that when executed by the enterprise processor, cause the enterprise platform to:
receive, from the user computing device, the input layers and training layers;
add, by the enterprise platform, the input layers and training layers to the enterprise deep learning module, wherein the enterprise deep learning module comprises input layers, training layers, and misconfiguration output layers;
input the configuration data associated with the application into the enterprise deep learning module;
process, by the enterprise deep learning module, the configuration data;
output, by the enterprise deep learning module, a misconfiguration indication, wherein the misconfiguration indication indicates the configuration data is misconfigured; and
block the enterprise platform from sending enterprise data to the user computing device based on the misconfiguration indication.

6. The system of claim 5, wherein the enterprise memory stores the computer-readable instructions that, when executed by the enterprise processor, cause the enterprise platform to:
update the configuration data based on the misconfiguration indication; and
send, by the enterprise platform and to the user computing device, the updated configuration data, wherein the user computing device updates the configuration data based on the updated configuration data.

7. The system of claim 1, wherein the first rule and second rule are dynamically updated by a rules engine.

8. The system of claim 1, wherein the malicious indication is related to specific vulnerabilities associated with the application.

9. The system of claim 1, wherein the user computing device is a smart phone, tablet, smart watch, or laptop.

10. The system of claim 1, wherein the user data comprises password information, transaction information, location information, or personal information associated with the user computing device.

11. The system of claim 1, wherein the unknown data is malware data or virus data.

12. A method comprising:
initiate, by a user computing device, an application session associated with an application, wherein the application session requests permission to access user data;
determine a first rule for a smart contract related to denying permission to the application session based on the application session bypassing the smart contract;
determine a second rule for the smart contract related to denying permission to the application session based on detecting unknown data not associated with the application in configuration data associated with the application;
determine a third rule for the smart contract related to shutting down the application session based on detecting a malicious indication in the configuration data;
generate, by a monitoring module, the smart contract assigned the first rule, second rule, and third rule;
extract, by the monitoring module, the configuration data associated with the application;
cause by the user computing device, the smart contract to be bound with the configuration data;
cause by the user computing device, the smart contract to be added to a distributed ledger for monitoring the application session;
determine, by the smart contract, the application session does not comply with the rules of the smart contract; and
deny, by the smart contract, the application session permission to access user data.

13. The method of claim 12, further comprising:
if the smart contract determines that the application session does comply with the rules of the smart contract, then granting, by the smart contract, the application session permission to access user data;
monitoring, by the smart contract, the application session executing on the user computing device, wherein the application session does comply with the third rule of the smart contract; and
receiving, at the user computing device and from an enterprise platform, enterprise data associated with the application.

14. The method of claim 12, further comprising,
if the smart contract determines that the application session does comply with the rules of the smart contract, then granting, by the smart contract, the application session permission to access user data;
monitoring, by the smart contract, the application session executing on the user computing device, wherein the application session does not comply with the third rule of the smart contract;
shutting down, by the smart contract, the application session based on the third rule assigned to the smart contract; and
blocking, at the user computing device and from an enterprise platform, enterprise data associated with the application.

15. The method of claim 12, further comprising:
inputting the configuration data into a deep learning module, wherein the deep learning module comprises input layers, training layers, and malicious output layers;
processing, by the deep learning module, the configuration data; and
outputting, by the deep learning module, a malicious indication for determining the third rule, wherein the malicious indication indicates the application session is executing malicious requests.

16. The method of claim 15, further comprising:
sending, by the user computing device, the input layers and training layers to an enterprise platform;
adding, by the enterprise platform, the input layers and training layers to an enterprise deep learning module, wherein the enterprise deep learning module comprises input layers, training layers, and misconfiguration output layers;
inputting the configuration data into the enterprise deep learning module;
processing, by the enterprise deep learning module, the configuration data;
outputting, by the enterprise deep learning module, a misconfiguration indication, wherein the misconfiguration indication indicates the configuration data is misconfigured; and
blocking the enterprise platform from sending enterprise data to the user computing device based on the misconfiguration indication.

17. The method of claim 16, further comprising:
updating, by the enterprise platform, the configuration data based on the misconfiguration indication;
sending, by the enterprise platform and to the user computing device, the updated configuration data; and
updating, by the user computing device, the configuration data based on the updated configuration data.

18. The method of claim 12, wherein the malicious indication is related to specific vulnerabilities associated with the application.

19. The method of claim 12, wherein the unknown data is malware data or virus data.

20. A method comprising:
initiate, by a user computing device, an application session associated with an application, wherein the application session requests permission to access user data;
determine a first rule for a smart contract related to denying permission to the application session based on the application session bypassing the smart contract;
determine a second rule for the smart contract related to denying permission to the application session based on detecting unknown data not associated with the application in configuration data associated with the application;
generate, by a monitoring module, the smart contract assigned the first rule and the second rule;
extract, by the monitoring module, the configuration data associated with the application;
bind the smart contract with the configuration data;
add the smart contract to a distributed ledger for monitoring the application session;
determine, by the smart contract, the application session does not comply with the rules of the smart contract; and
deny, by the smart contract, the application session permission to access user data.
